(19) United States
(12) Patent Application Publication
(10) Pub. No.: US 2018/0171975 A1
(43) Pub. Date: Jun. 21, 2018

(54) MULTI-FUNCTIONAL FLAP USED AS A BACK-FLOW FLAP

(71) Applicant: Dieter Röhm, Reutlingen (DE)

(72) Inventor: Dieter Röhm, Reutlingen (DE)

(21) Appl. No.: 15/545,830

(22) PCT Filed: Jan. 24, 2016
(86) PCT No.: PCT/DE2016/100029

§ 371 Date: Dec. 1, 2017

(30) Foreign Application Priority Data
Jan. 24, 2015 (DE) 20 2015 000 665.5
Aug. 13, 2015 (DE) 10 2015 113 374.4
Sep. 1, 2015 (DE) 10 2015 114 617.7

(51) Int. Cl. F03D 7/02; B64C 9/02; B64C 3/46; B64C 9/18; B64C 9/20; F03B 3/12; F03D 1/06; F03D 80/30; F15D 1/10

(52) U.S. Cl. CPC F03D 7/0232; F05B 2270/404; F03D 7/0252; B64C 3/46; B64C 9/18; B64C 9/20; F03B 3/123; F03D 1/0675; F03D 1/0633; F03D 80/30; F15D 1/10; F05B 2210/16; F05B 2240/311; F05B 2240/98; F05B 2250/183; F05B 2260/507; F05B 2260/901; F05B 2260/964; F05B 2270/402; B64C 9/02

(57) ABSTRACT

The invention relates to a device of a safety system and/or resource and energy-efficiency improvement system for influencing the flow around an aero- or hydrodynamic body, preferably an aerofoil, according to the principle of a back-flow flap, characterized in that: said device, together with the aero- or hydrodynamic body, in particular aerofoil, form at least a partial shift of the delimitation of the flap region by means of the back-flow flap and the delimiting component thereof when the back-flow flap is partially and/or completely raised, thus influencing the trailing edge separation vortex/vortices and/or the flap separation vortex/vortices; and in that the delimitation of the flap region shifts completely up to or beyond the profile trailing edge, or shifts only to a section in front of the profile trailing edge. The delimitation component is movably connected to the aerofoil by means of a basic element and is preferably permanently secured and/or releasably secured for maintenance purposes, thus ensuring a long service life for the rotor blade and/or wind turbine and/or flap system, preferably >5 years, particularly preferably >10 years, and most particularly preferably >=20 years, and/or thus optionally allowing simple removal/replacement.

### CROSS-REFERENCE TO RELATED APPLICATIONS

This application is a Section 371 National Stage Application of International Application No. PCT/DE2016/100029, filed on 24 Jan. 2016, which published as WO 2016/116102 on 28 Jul. 2016, which claims priority to German Patent Application Nos. 20 2015 000 665.5, filed on 24 Jan. 2015; 10 2015 113 374.4, filed on 13 Aug. 2015; and 10 2015 114 617.7, filed on 1 Sep. 2015, the contents of which are hereby incorporated by reference in their entirety.

### DESCRIPTION

### Technical Field of the Invention

Birds naturally have back-flow flaps.

Accordingly, the mode of operation of these flaps can be interpreted as follows:

Raising the flap causes a stationary flap vortex to form in front of it, the flow direction of said vortex pointing from back to front on the upper wing face. The flap vortex extends forwards almost into the nose region. It thus in effect fills the triangular region between the upper wing face, the upper flap face and the surrounding airflow. By comparison with the bare, separated profile, the flow is deflected downwards by this flap vortex. This flap vortex may be interpreted as a profile change (with a free flow boundary). Directly behind or below the flap, there is a second vortex region, which encloses a larger but possibly weaker trailing edge vortex. In this trailing edge vortex too, the flow is directed from back to front along the wing surface. The two vortices thus rotate in the same direction. They are both stationary.

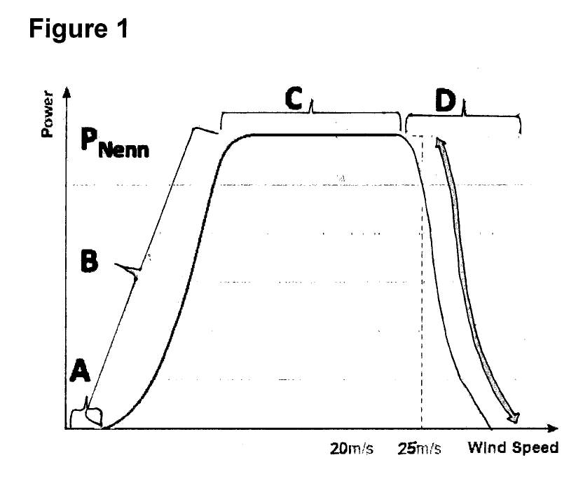

These vortices have been analysed more precisely by flow visualisation using smoke-based and thread-based indicators (FIG. 1). A model wing a: with separated flow; b: with separated flow with a flap (from prior art, Patone G. et al.)

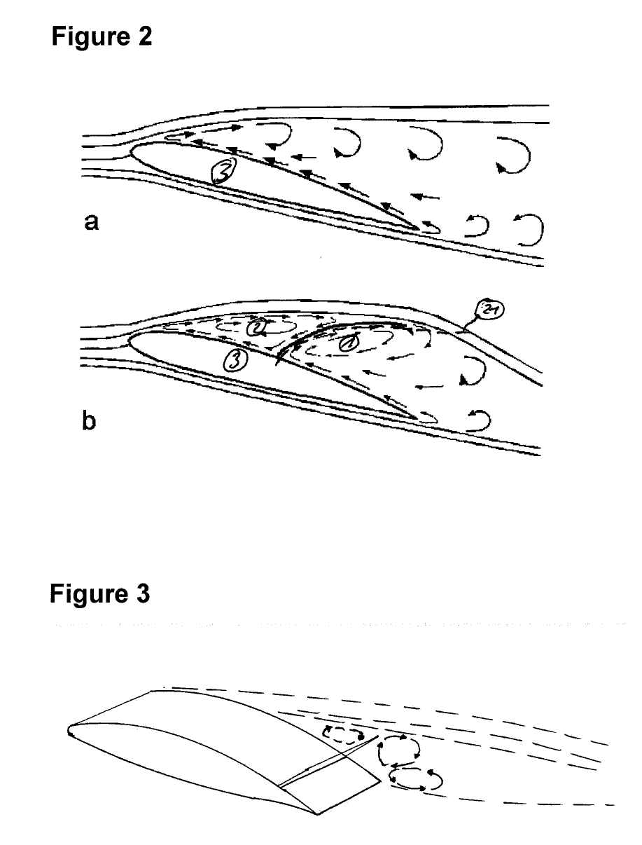

(FIG. 2) Simulated flow relationships on an aerofoil comprising a back-flow flap (from prior art, Meyer Robert K. J.)

The invention relates in particular to a back-flow flap on a wing, in which the lift is further increased and/or the minimum (take-off) speed is reduced by comparison with conventional back-flow flaps (region of improvement A+B in FIG. 1) by shifting and/or reducing the trailing edge separation vortex. Further, by providing a combination of a passive and active back-flow flap, a precautionary/preventative reaction to an existing gust situation is made possible as a safety system (region of improvement D: overspeed control). In particular, the lower long-term load alternation (in particular of the maximum values) of the long rotor blades or wings which can thus be achieved is of great significance for the actual service life thereof because of fatigue phenomena, in particular in glass-fibre-reinforced or carbon-fibre-reinforced plastics materials used therein. (It has been found that for example the wing deformation increases over the course of the service life, but this needs to remain within a limited range). Moreover, for situations of this type, an active back-flow flap which is simple to activate and which has a braking effect is also made possible (region of improvement A: startup aid+D: overspeed control).

This makes improved energy efficiency possible, for example during take-off and landing in aeroplanes or for example in low-wind situations (by way of increased lift) and high-wind situations (in particular in very large wind turbines having rotor blades over 50 m long) in wind turbines (as a result of shorter shut-down times or cut-offs). Also, as a result of the increased lift, at low fluid speeds either the minimum speed can be reduced and/or the size of the wing/rotor can be smaller, resulting in a reduction in material and reductions in costs (improvement of efficiency in resources and material).

Moreover, the device according to the invention in the form of a wind turbine rotor blade having a passive and/or active flap system, which, to improve the output at least in the regions of improvement A and/or B and/or C and/or D, can be used in the form of an actuator element fillable (inflatable) with a fluid and if necessary can in a very simple manner be retrofitted and/or attached and/or replaced on a flap as required,

in the function of a system for increasing the rigidity and/or limiting the excursion of the flap, and/or a system having a long service life and high capacity for retrofitting, and/or a base element which reinforces a rotor blade and/or a lightning protector, and/or a noise-reducing lift element and/or base element, and/or an oscillation attenuation system comprising at least one oscillation attenuation element, and/or a storm protector/overspeed protector, and/or a startup aid in low wind, and/or an overspeed protector and/or oscillation attenuation system using at least one lift-reducing lift element and if applicable comprising sealable pressure compensation openings and/or an ice and snow removal system,
is characterised in that means for increasing the rigidity of the flap and/or means for limiting the excursion are used, and in that the excursion limitation limits the opening angle of the flap of <90 degrees, preferably <75 degrees, particularly preferably <60 degrees, and in that at least one actuator element and/or a component thereof is fillable (inflatable) with a fluid, and can simultaneously be folded at least in the initial state.

### Prior Art

Patone G et al.: “Aeroflexible surface flaps as back-flow brakes” in Technical Report TR-96-05, 1.5.1996 discloses passive back-flow flaps made of resilient material, which are very close to bird feathers in nature. These vortices have been analysed more precisely by flow visualisation using smoke-based and thread-based indicators (FIG. 1). A model wing a: with separated flow; b: the same but with a flap. These have a relatively large lift-increasing effect, and have, in a slightly air-permeable form, low hysteresis when the flap is raised and lowered.

A delay in the separation/stalling of the flow on the upper profile face was found.

A drawback of these embodiments is the short service life of the materials used under actual weather conditions such as ice, rain, sand, UV radiation. Moreover, in this context the low mechanical stability under conditions of use, such as strong gusts and winds, and the potentially required cleaning of an aerofoil of an aeroplane are disadvantageous.

Experimental analyses using surface flaps/back-flow flaps in a wind tunnel have been carried out on aerofoils of fixed-wing aircraft so as to research the potential thereof for influencing flow separations (see Meyer, Robert K. J., Experimental analyses of back-flow flaps on aerofoils for influencing flow separations.

The back-flow flaps used herein have a rigid plate as a flap and are suspended in an articulated manner using resilient connecting elements.

Medium increases in lift of up to 15% were measured. A delay in the separation/stalling of the flow on the upper profile face was found.

A stabilising effect on the wake and the vortex structures forming there was detected. Considerable hysteresis in raising and lowering the flaps was found, and this has considerable drawbacks for optimum lift during operation.

Dissertation TU Berlin, Hermann Föttinger Institute for Fluid Dynamics, Mensch & Buch Verlag, ISBN 3-89820-205-4).

DE 102010041111 discloses a rotor blade for a driven horizontal rotor of a helicopter or gyrocopter comprising at least one flap which is integrated into the rotor blade and which is pivotable relative to a main body of the rotor blade about a longitudinal axis of the rotor blade, said axis being positioned at the front in the direction of rotation of the horizontal rotor. The object of the invention is to provide a rotor blade in which, by way of passive measures, the dynamic flow stalling is shifted towards higher angles of attack or towards higher speeds. This is implemented by means of a resilient back-flow flap.

In the novel rotor blade, the flap has a base position in which it is positioned flat against the upper face of the main body. In other words, this is what is known as a surface flap. This flap is passively pivotable out of the base position thereof away from the upper face of the main body counter to a resilient restoring force. This means that the flap is brought into a functional position, pivoted away from the upper face of the main body, by forces resulting from the operation of the rotor blade, in other words aerodynamic forces and potentially inertial forces, and not actively by actuators of any type. Accordingly, it is sufficient to tune the resilient restoring force on the flap of the novel rotor blade to the position, shape and dimensions thereof. It is not necessary to provide an actuator setup for the flap or an actuation system for an actuator setup of this type.

DE 10201004111 discloses a rotor blade for a wind turbine. The central idea of the invention is that at least one aerodynamic element is mounted on the surface of the rotor blade by means of a rotary joint and that the aerodynamic element is arranged on the surface of the rotor blade in such a way and configured in such a way that the aerodynamic element automatically pivots out at a predetermined flow merely as a result of the force of a flow on the surface of the rotor blade. As a result, advantageously the enlargement of a separation zone at the rotor blade, in particular at steeper angles of attack, can be reduced or completely prevented. In this context, the aerodynamic element is a passive aeroelastic back-flow flap. In reality, fluttering of the back-flow flap is a drawback, and can also produce noise and is problematic for the service life.

JP 2004183640 discloses a rotor blade for a wind turbine, which blade has an active plain flap having a back-flow flap which is arranged on the lower rotor face and which increases the lift and thus the energy efficiency. The rotor blade is further prevented from breaking in a heavy wind.

A drawback in this context is the use of movable plain flaps, which for one thing have to be highly resilient and are high-maintenance (experience from aircraft construction). Further, these movable parts of the plain flap are very cost-intensive to manufacture. The problems regarding icing up also apply.

U.S. Pat. No. 7,293,959 B2/EP 1623111 B1 discloses a rotor blade which consists of an active resilient (brake) flap (only for reducing lift) and an activating means for a wind turbine and which is part of a lift-regulating means. By way of wind measurement and wind turbine rotor load measurements, the lift-regulating means can actuate and advantageously influence the back-flow flaps.

A drawback of this solution is that the advantages of the passive back-flow flap due to the aerodynamic self-regulation thereof and in particular the advantages of the increase in lift and improvement in energy efficiency cannot be exploited.

### OBJECT OF THE INVENTION

An object of the invention is to improve the energy efficiency of aerodynamic/hydrodynamic bodies, in particular
a) aircraft, by way of higher wing lift (at least in high-lift situations such as take-off and landing),
b) energy generating systems, by way of higher lift in high-lift situations at a low fluid speed, and at high fluid/wind speeds by lift reduction/a braking effect, as a result of higher availability (for example shorter shutdown times due to strong winds and the resulting improved annual energy output) of the energy generating system.

A further object of the invention is, optionally simultaneously, to provide a safety means on a wing with which the susceptibility of the wing to gusts, in particular in a strong wind, is reduced by an actively activated back-flow flap having for example a slowly increasing braking effect. Said flap can also react rapidly when required, in such a way that it is also possible to react to compensate individual gusts in this manner.

Further, a multifunctional flap is provided which can additionally compensate/attenuate different oscillation forms of the wind turbine/rotor/rotor blade by means of an active back-flow flap by means of actuators and/or by means of mass inertia elements (weights). This can lead to an increased service life of components and of the wind turbine itself.

Further, said flap can also proactively remove snow and ice accumulation at least in part. The embodiments according to the invention can in particular be retrofitted and in some variants do not require any major alterations to the wind turbine or aircraft.

Said flap can also be combined with noise-reducing measures on the lift element and/or base element according to the prior art, such as a toothing. In this context, the base element may take on a function of reinforcing the back-flow flap and/or the wing/rotor blade. Moreover, the device according to the invention in the form of a wind turbine rotor blade having a passive and/or active flap system, which, to improve the output at least in the regions of improvement A and/or B and/or C and/or D, can be used in the form of an actuator element fillable (inflatable) with a fluid and if necessary can in a very simple manner be retrofitted and/or attached and/or replaced on a flap as required,

in the function of a system for increasing the rigidity and/or limiting the excursion of the flap, and/or a system having a long service life and high capacity for retrofitting, and/or a base element which reinforces a rotor blade and/or a lightning protector, and/or a noise-reducing lift element and/or base element, and/or an oscillation attenuation system comprising at least one oscillation attenuation element, and/or a storm protector/overspeed protector, and/or a startup aid in low wind, and/or an overspeed protector and/or oscillation attenuation system using at least one lift-reducing lift element and if applicable comprising sealable pressure compensation openings and/or an ice and snow removal system,
is characterised in that means for increasing the rigidity of the flap and/or means for limiting the excursion are used, and in that the excursion limitation limits the opening angle of the flap of <90 degrees, preferably <75 degrees, particularly preferably <60 degrees, and in that at least one actuator element and/or a component thereof is fillable (inflatable) with a fluid, and can simultaneously be folded at least in the initial state.

A further object of the invention is to exploit the advantageous properties of existing technologies (prior art of a back-flow flap on a wing so as to obtain a configuration of the invention which is optimal overall in view of the requirements, in particular in wind turbines.

### Solution

An object of the invention is to disclose a back-flow flap on a wing, in which flap the lift is further increased and/or the minimum speed is reduced in particular by reducing and/or acting on the trailing edge separation vortex.

Further, by providing a combination of a passive and active back-flow flap, a precautionary/preventative reaction to an existing gust situation is made possible as a safety system or part of a safety system. This can be done well in a period of a few seconds/minutes given appropriate reaction times of the active back-flow flap.

Moreover, an active back-flow flap which is simple to activate and which has a braking effect is disclosed.

The combination of an active and passive back-flow flap makes possible a multifunctional flap system having the capability to compensate/attenuate various oscillations in the wind turbine/rotor/rotor blade, in particular in stalling operation and in the overspeed range.

### DESCRIPTION OF THE INVENTION

### Field of Use

The devices and methods according to the invention can be used in all aerodynamic and/or hydrodynamic objects, preferably wings or rotors of vehicles, in particular in aircraft and energy generating systems.

Generally, the distinction should be made that an embodiment referred to as a back-flow flap is suitable for generating a higher lift coefficient C_{L} than for a conventional wing at higher angles of attack alpha (17) of the wing. The back-flow flaps (8, 9, 10) according to the invention are even suitable for generating an even higher lift coefficient C_{L} by shifting the trailing edge vortex (1).

Generally, back-flow flaps (8, 9, 10) of this type in an active form having an actuator element (22) are suitable to be used as a braking flap even at higher speeds and a low angle of attack alpha of the wing.

The regions of improvement/potentials for improvement A, B, C, D which may take effect or have an advantageous energy efficiency in the variants according to the invention of the invention are shown in FIG. 1 in a graph having a typical curve progression, showing wind speed on the X-axis and the power output of the wind power plant on the Y-axis.

The back-flow flaps known thus far in aviation have a rigid or flexible flap and, as a second component, a joint. Stop means/excursion limiting means based on strings or bevels are optionally further used.

As a result, in prior art technologies, the trailing separation vortex, referred to herein as the trailing edge separation vortex (1), can form to the size shown over the trailing profile edge (6) of the wing profile (3) at the angle of attack alpha (17) below the prior art back-flow flap (4) (FIG. 2). The flap region boundary (21)=edge of the region of the action of the trailing edge separation vortex can be seen therein.

FIG. 3 shows a 3D computer simulation of the back-flow.

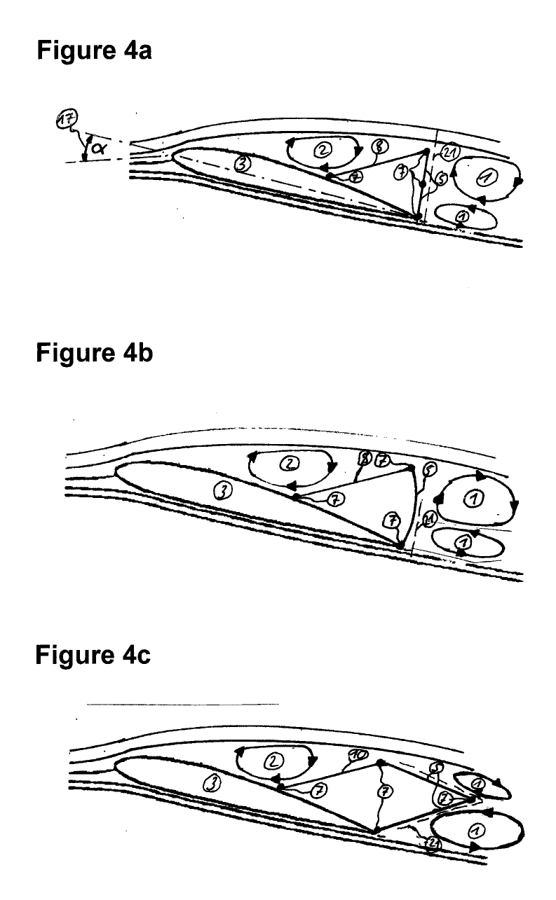

FIG. 4 in variations a, b, c: generally, all variants shown herein of the back-flow flaps (8, 9, 10) according to the invention have the property that, together with the aerodynamic or hydrodynamic body, in particular wing, the back-flow flap (8, 9, 10) and the boundary component(s) (5) thereof form/cause, at least in part, a shift in the flap region boundary (21) when the back-flow flap (8, 9, 10) is partially and/or completely raised, influencing the trailing edge separation vortex/vortices (1) and/or flap separation vortex/vortices (2) as a result.

In this context, the left edge (position) of the trailing edge separation vortex (1) corresponds to the flap region boundary (21). Thus, as a result of the spatial extension/action of the back-flow flap (8, 9, 10) according to the invention, the flap region boundary (21) of the back-flow flap (8, 9, 10) according to the invention is in effect shifted from left to right, towards or in extreme cases even beyond the trailing profile edge (6), from the region of the prior art back-flow flap (4). Further, the back-flow flap (8, 9, 10) according to the invention has a relative rigidity which is higher as a result of the additional components thereof and a higher attenuation of oscillations, since the fluid, preferably gas, such as air, of the actuator element (22) also acts to attenuate oscillations. This novelty according to the invention thus also results in a higher lift coefficient C_{L} than in a prior art back-flow flap (4).

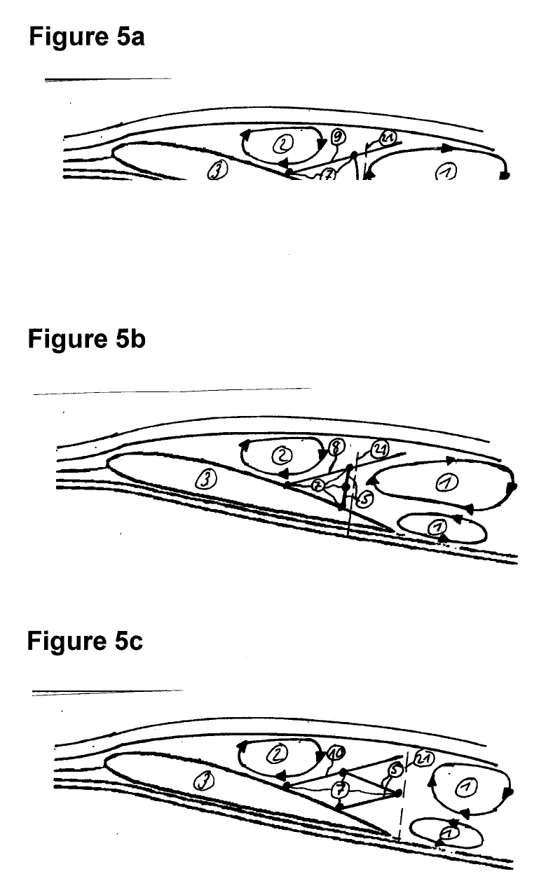

In this context, the flap region bounding (21) may take place completely (FIG. 5) to or past the trailing profile edge (6) or else only to a part to the left before the trailing profile edge (6) (FIG. 5). This results in a larger or smaller distance between the flap separation vortex (2) and the trailing edge separation vortex (1), which distance, in the case of a back-flow flap (4) according to the prior art, only has the thickness of the back-flow flap material (4).

Even shifting the flap region boundary (21) in part (FIG. 5) leads to a shift (position) and/or reduction in the trailing edge separation vortex (1) and/or flap separation vortex (2), leading to an increase in lift (lift coefficient C_{L}) and/or reduction in resistance. Thus, by contrast with a prior art flap (4), not just 2 pressure regions in front of and behind the back-flow flap (4) occur, but 3 pressure regions, in the actuator/back-flow flap (active: pressure of the fluid/gas filling region (14) or passive: ambient pressure on the openings for example of a passive parallelogram back-flow flap (10)) and behind the back-flow flap (8, 9, 10).

By way of example, FIG. 4 shows the complete shift of the flap region boundary (21) by the boundary component (5) when raised on (a) a triangular (8), (b) a parallelogram (9) and (c) a circle segment (10) back-flow flap.

In this context, this back-flow flap (8, 9, 10) may be formed at least of the flap (4) and the boundary component (5) and a joint (7).

In addition, it may consist of the support face/connecting point (16) and/or parallelogram or triangular or circle segment (area) boundary components (5).

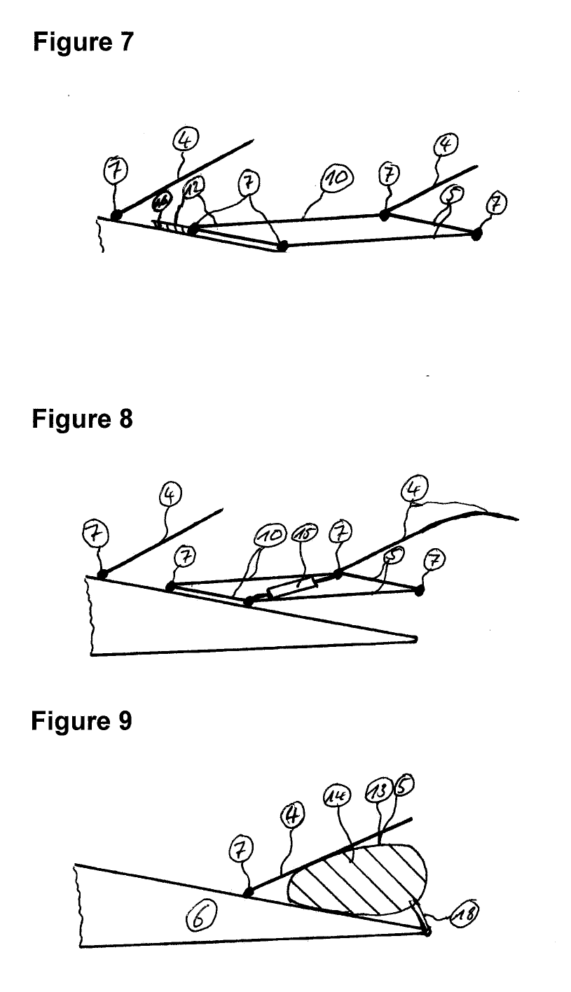

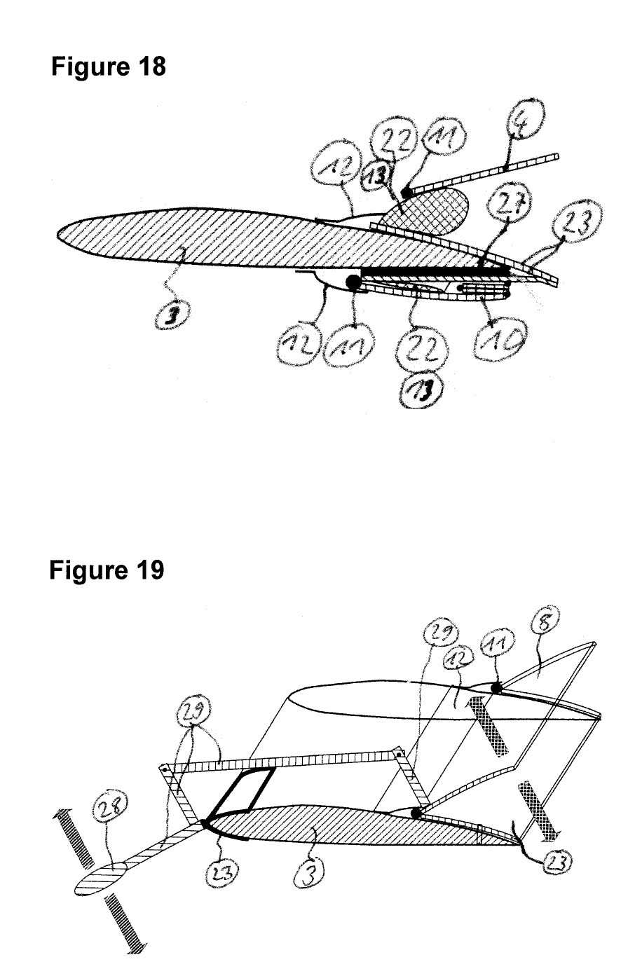

This support face/connecting point (16) may also be arranged before the back-flow flap counter to the flow direction (FIG. 7). This support face/connecting point (16) may also, as in FIGS. 17 and 18, consist of a base element (23) projecting beyond the trailing edge and a fixing means (27).

In principle, the back-flow flap (8, 9, 10) according to the invention may also be formed from a plurality of these components, and also as a polygon.

As in the prior art back-flow flap, the flap is required to be movable and/or movably attached. This is further provided by the joints (7), preferably made of resilient materials (11) such as films or textiles or adhesive strips, hook and loop fastener, preferably textile-reinforced or fibre-reinforced adhesive strips. In particular textile fibre, glass or aramid fibre joints are particularly durable and smooth-running. In particular the weathering resistance to UV radiation is of importance for the service life in this case. Conventional hinges, joints, such as piano hinges or ball joints, or other thin-walled resilient materials may also be used. Materials for the back-flow flap having a thickness of at most 4 mm, preferably having a thickness of at most 2 mm and particularly preferably having a thickness of at most 1 mm, are used.

The materials used here likewise have to be weather-resistant and somewhat light. Lightweight materials such as aluminium, plastics materials, GFRP, CFRP, aramid-fibre-reinforced or basalt-fibre-reinforced plastics materials are preferably used here, the plastics material matrix preferably having a high weathering resistance, as PMMA does for example, and simultaneously being easy to hot-form/deform/thermoform. In this context, in particular textiles in woven, knitted, interlaced and non-woven form may be used. As a result, edge reinforcements and/or beads and/or hinges can also be implemented on the back-flow flap in a simple manner. A type of wing scissors (or pincers) for fixing in a particular region can be detachably fixed for example by gripping and/or frictional forces (non-slip material/mat). This can thus be used as a base element, for example for the variants disclosed in FIG. 19-21, in particular for retrofitting.

The outer shape of the back-flow flap may be rectangular in the conventional manner, but is preferably a parallelogram outer contour (plan view when folded) because of the rotational flow (oblique flow on the profile) at the rotor blade of the wind turbine. It can preferably further be deformed/curved in 2 or 3 dimensions so as to be positioned optimally on the profile. This curvature may preferably be sufficient that the backflow flap module can be used on the largest possible regions of the rotor blade (as a result of the curvature of the profile) (even in such a way that the hose fits below it well; for a parallelogram back-flow flap without an additional hose, only slight curvature is expedient, in such a way that the flap is positioned against the profile), since this slight to medium curvature has little aerodynamic influence at speeds of V_{Nominal} and above. (At the prevailing profile accuracies of a few cm of deviations in the profile thickness in the construction of wind turbine rotor blades, this is of subordinate importance, since the turbine delivers full output from V_{Nominal}=8-12 m/sec upwards, and subsequently the angle of attack is generally incrementally reduced with increasing wind speed by way of the pitch control/regulation until shutdown at V_{MaxNormal} at generally 25 m/s).

In very safe systems, a double-walled hose or the combination of the closed parallelogram back-flow flap and an internal hose can be used, resulting in redundant and diverse and thus very high safety. A magnetorheological actuator could also be combined with a pneumatic emergency activation system.

Actuator elements (22) may be activated by way of known sensor technology in wired or wireless form. Preferably an optical camera system is used, which controls all back-flow flaps on a rotor blade and optionally simultaneously monitors the load on the wing/rotor blade.

The back-flow flap (4, 8, 9, 10) can have stops (particularly laterally) for limiting the excursion, provided by way of means for limiting the excursion (26), for example ropes, rubber, wires, rods, levers, strips, nets, springs, walls, films, folding elements. The excursion may also be limited by the actuator itself in that the back-flow flap is fixed thereto or integrated therein.

In this context, the actuator element (22) may be much smaller than the back-flow flap so as to bring about a braking effect of the back-flow flap, for example in the event of high wind. In this case, the corresponding forces are generated by way of the hydraulic or pneumatic or magnetorheological pressure in the actuator element (22) and the lever arm transmission thereof to the flap, which is subjected to the impact pressure of the back-flow flap. The impact pressure may also be used as a sensor variable for the pressure activation/control/regulation.

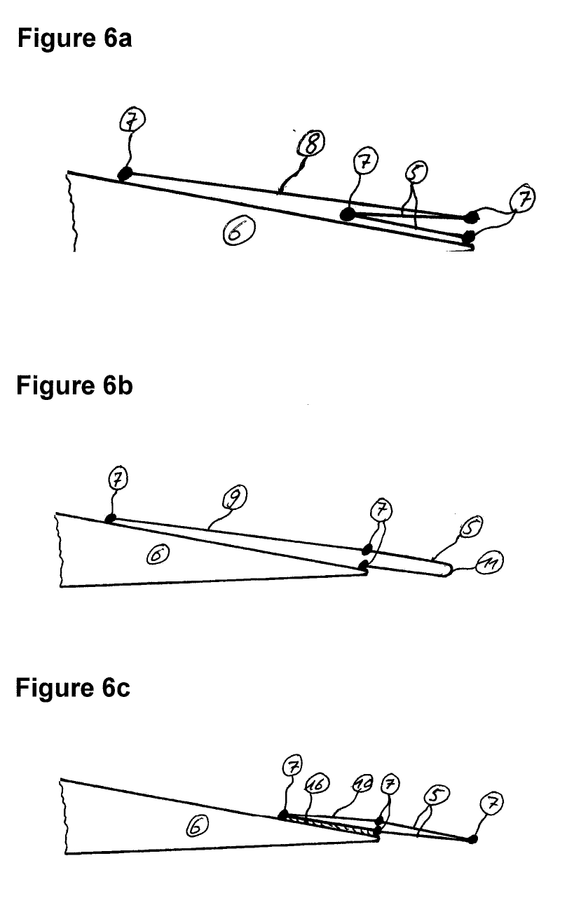

The support face/connecting point(s) (16) of the back-flow flap with respect to the wing are shown by way of example in FIGS. 6c and 7, and may for example reliably be implemented to be very durable, in particular including retroactively, but also detachable, for example by gluing over a large area (glues which are soluble for example under the effect of temperature or electromagnetic fields such as are used for example in the automobile industry). The support face/connecting point(s) (16) of the back-flow flap may also be considered as a base element (23), from a support face of 5% of the back-flow flap area upwards, in particular from a support face of 10% of the back-flow flap area upwards, more particularly from a support face of 20% of the back-flow flap area upwards, preferably from a support face of 30% of the back-flow flap area upwards.

Further, this may also take place in front of the back-flow flap (4, 8, 9, 10), in the same way that a superelevation occurs during retroactive attachment, which as shown in FIG. 7 can optionally be implemented in combination with the oblique or curved flow-promoting flap transition (20), for example of a springy material (12). A further alternative is fixing directly to the joint (7) (for example screwing, riveting, gluing) or to the for example resilient joint itself using high-performance adhesive strips.

In FIG. 5, the partial shift of the flap region boundary (21) by the boundary component(s) (5) when raised is shown by way of example by way of a triangular (8), a circle segment (9) and a parallelogram (10) back-flow flap. It can be seen that in this case the trailing edge separation vortex (1) is shifted in position towards the trailing profile edge (6). This results in the aerodynamic/hydrodynamic advantages of an increase in lift and/or reduction in minimum speed (for the contact of the flow when the wind turbine starts so as to produce sufficient lift for startup). This brings about some of the improvements in energy efficiency, in particular in regions for improvement A+B (FIG. 1), as a result of the increase in the lift coefficient C_{L}.

The boundary component may optionally only be formed for intermittently/situationally bounding the trailing edge separation vortex and/or flap separation vortex (2), in the form of a roller and/or blind and/or shutter.

FIG. 6 shows the complete shift of the flap region boundary (21) by the boundary component (5) when closed on a trailing profile edge (6) by way of example by way of a triangular (8), a circle segment (9) and a parallelogram (10) back-flow flap.

At small angles of attack α (17), which occur at higher speeds, the flow and the back-flow flaps are positioned against the profile, just as is known in prior art back-flow flaps.

The bounding of the region brought about by the boundary component (5) and all components of the back-flow flap (4, 8, 9, 10) may in this context too take place using fluid-permeable materials comprising small (micro) or larger (macro) openings, such as toothed plate, perforated films, slit films or wovens or non-wovens or plates, and in the form of meshes and nets. The effect thus achieved of better/lower hysteresis of the back-flow flaps may also be brought about by ducts on the basis of embossments/stampings. Known materials open to diffusion as are used in the construction or clothing sector and which are appropriately weathering-resistant and long-lived may also be used here. What are known as shutter valves (primitive valves which open and close as a result of air pressure differences) may also be used here.

Active or passive articulated rods or levers may also, optionally additionally, further be used for this purpose for shifting the flap region boundary (21). Further, flap regions can also, optionally additionally, be bounded in the longitudinal direction of the wing (from the wing root to the wing tip) using known rudder technologies, for example using winglets, flow directors, flow splitters, turbulators such as vortex turbulators or spiral turbulators.

The material for the back-flow flaps consists for example of flexible and/or resilient thin materials, for example of metal films, in particular comprising reinforcing/embossed curved structures as reinforcement and preferably made of plastics materials, most preferably plastic materials, very light and rigid fibre-reinforced plastics materials made of GFRP, CFRP, basalt-fibre-reinforced, aramid-fibre reinforced. As a result, flexible and rigid back-flow flaps can be formed. As a result of the rigidity or partial flexibility, oscillations in the back-flow flap are suppressed or attenuated and a low adjustment hysteresis is achieved. Metal and/or plastics materials, for example having small-scale (honeycomb structures on the scale of mm to several cm) and large-scale (wing curvature) curvature structures as reinforcements, may also additionally be used. This is a very material-efficient variant for saving on material and increasing rigidity.

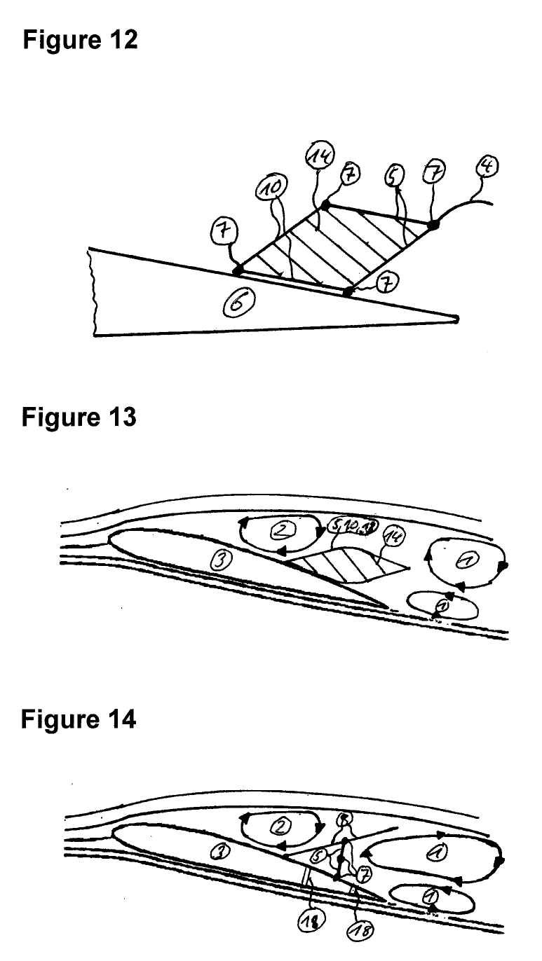

In highly resilient back-flow flaps, this rigidity is correspondingly lower, and this may be advantageous in the edge region of the back-flow flap (see FIGS. 11 and 12). A back-flow flap (4, 8, 9, 10) may also be formed in such a way that the material thickness decreases for example in a wedge shape so as to increase the flexibility in the edge region externally. This may naturally also take place in steps.

FIG. 7 shows an example combination of a plurality of back-flow flaps. In this context, prior art back-flow flaps (4) are combined with a parallelogram back-flow flap (10) according to the invention at a trailing profile edge. There is an option for free combination, such as fixing the connecting point for the wing (16) of the prior art back-flow flaps (4) on the parallelogram passive back-flow flap (10) according to the invention.

Further, the parallelogram back-flow flap (10) may contain and/or consist of a springy material (12), which returns the parallelogram back-flow flap (10) to the closed position by spring force. This may also take place in reverse, and the parallelogram back-flow flap (10) is only held closed by underpressure and is raised again by spring force by ventilation. This is conceivable for example for regulation operation and/or emergency operation, in which the parallelogram back-flow flap (10) is permanently raised (special stalling operation of the wind turbine comprising a back-flow flap (8, 9, 10)). In this context, there is reduced development of noise by comparison with wind turbines having stalling operation/regulation. A corresponding variable control/regulation of the back-flow flap (8, 9, 10) is disclosed in relation to overspeed control.

FIG. 8 shows an example combination of a plurality of back-flow flaps. In this context, prior art back-flow flaps (4) are combined with a parallelogram back-flow flap (10) according to the invention at a trailing profile edge. In this case, the use of a strong, flexible trailing edge of the back-flow flap (4, 8, 9, 10) is also possible. The components of the back-flow flap (4, 8, 9, 10), in particular this trailing edge, may be slitted, jagged, toothed, undulating or otherwise altered so as positively to influence the flow (including bionic effects such as the aerodynamically favourable sharkskin structure). This can positively influence the aerodynamics/hydrodynamics and also the tendency of the flaps towards fluttering/oscillation.

FIG. 8 further shows an actuator for active activation of the back-flow flap (10), for example in the form of a hydraulic or pneumatic cylinder. In principle, any form of actuator may be used, for example mechanical (levers, ropes, toothed wheels, toothed belts) and/or electrical (linear or rotational electric motor, electromagnets, piezo actuators) and/or pneumatic/hydraulic (cylinders, pneumatic muscles, hoses, balloons, cushions). However, the advantageous embodiment of the hydraulically or pneumatically or magnetorheologically activated actuator element (22) in the form of a preferably foldable hose (13) is preferred. In addition to the desired increase in lift, this also makes it possible to implement the lift-reducing and/or resistance-generating and/or braking variants of the back-flow flap in the form of a braking flap (in particular at smaller angles of attack (17)).

This is used in particular at high fluid/wind speeds, for example for braking the rotor against overload in the context of a safety system (region for improvement D, FIG. 1). As a result, shorter shutdown times can be achieved in the event of high wind, such as in particular in wind turbines located offshore, coastally and in mountainous regions. This increases the annual energy output and thus improves the energy efficiency.

Further, providing a combination of a passive and active back-flow flap makes possible a precautionary/preventative reaction to a pre-existing gust situation as a safety system or part of a safety system. At corresponding reaction times of the active back-flow flap (8, 9, 10), depending on the actuator type and configuration, this can take place in a period even of fractions of a second or preferably of a few seconds, and in minutes for example in cases of predictive activation. Depending on the type and aim of the activation, returning the active back-flow flap may take longer (system-optimised technology). However, the advantageous embodiment of the hydraulically or pneumatically or magnetorheologically activated actuator element (22) in the form of a preferably foldable hose (13) is preferred. The passive back-flow flap (4, 8, 9, 10) reacts to changes in angle of attack of the flows, in particular due to gusts which lead to high angles of attack, relatively rapidly, within a few seconds/fractions of a second.

Example variants of the active back-flow flap (8, 9, 10) are shown in FIG. 9, 10, 11, 12. These may also be activated for example by supplying fluid/air by way of the fluid flow (impact pressure) without external energy for example by means of air inlets in the flow direction. Equally, it is conceivable for them to be deactivated by underpressure-generating nozzles/pipes such as the Venturi nozzle, Prandtl tube, Reichman nozzle, Braunschweig nozzle, Pitot tube, by way of the ambient airflow. This has the advantage that no external energy is required, and thus merely a fluid speed measurement is required for a relatively simple solution to raising the back-flow flap (8, 9, 10) using known technologies. This could take place predictively, since the raising time from a slightly excessive impact pressure will take quite some time (hysteresis between raising and lowering seems expedient). For an actuator supplied from for example a fluid overpressure or underpressure reservoir, this can take place very rapidly by comparison.

FIG. 9 shows a prior art back-flow flap (4) combined with a boundary component (5) in the form for example of a balloon or hose or cushion (13), which is simultaneously also hydraulically or pneumatically or magnetorheologically activated as an actuator and thus becomes an active back-flow flap (8, 9, 10). The fluid/gas filling region (14) is shown shaded here. A fluid/gas connection (18), for the possibility of filling with for example air, may, for example in retroactive installation, be attached in a flow-promoting and cost-effective manner via a hose line for example on the trailing profile/wing edge (6). A connection within the wing may also be used to supply the fluid. In principle, the boundary component may be configured in any desired manner.

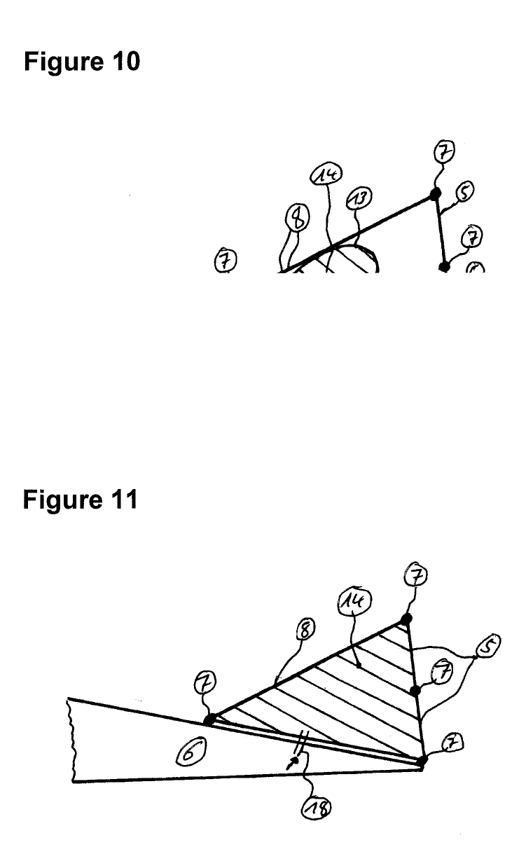

FIG. 10 shows a triangular back-flow flap (8) which has for example an aforementioned hose (13) as an active actuator.

FIG. 11 shows a triangular back-flow flap (8) which is for example completely closed in the three-dimensional implementation thereof so as to be able to be filled with for example air via a fluid/gas connection (18) and thus itself acts as an actuator. In this case too, a correspondingly, for example triangularly configured or folded hose may be used. This is a very simple and very reliable actuator setup.

FIG. 12 shows a parallelogram back-flow flap (9) which is for example completely closed in the three-dimensional implementation thereof so as to be able to be filled with for example air via a fluid/gas connection (18) and thus itself acts as an actuator. In this case too, a correspondingly configured, for example parallelogramically configured or round or flat or folded hose (in particular at the ends) may be used. In this case, integrated combination with a flexible prior art back-flow flap (4) rigidly attached to the parallelogram back-flow flap (8) is also shown, which flap can raise itself as a result in the direct fixing thereof in the case of active activation.

FIG. 13: A particularly preferred and simple embodiment of the back-flow flap (10), in particular the active back-flow flap (10) according to the invention, which is formed merely by an in particular closed hose (13) which is pressed flat and/or folded, is surprisingly advantageous. As a result of the plastics material hose being inflated, for example at one end via a fluid/gas connection (18), this hose (13) rises similarly to a parallelogram back-flow flap (10). This hose is thus simultaneously a flap, a boundary component (5) and an actuator (22). This is particularly advantageous for cost-effective retrofitting for example for wind turbines. In a rigidly raised position, this or a similar embodiment can also be used as a turbulator/vortex generator. This can reduce in height for example as a result of the impact pressure of the flow at higher speeds, and thus adapt in intensity to the small vortex generation in a simple manner, and thus make the desired small turbulence generation possible at lower speeds. In principle, other actuators such as levers and rods, electromagnets, rudder engine drives (for example model construction) can also be used for this purpose. The magnetorheological actuator variant is also of interest here, since when it has attached or even integrated the electromagnetic field generator to or into the hose (13) this could be retrofitted in a very simple manner by attaching to the wing/rotor blade. It is also conceivable to raise a somewhat more rigid outer and larger hose using a smaller actuator hose, in such a way that the outer and larger hose acts as a back-flow flap (approximately in a parallelogram shape).

It is also conceivable for this aforementioned outer and larger hose to be composed of 2 curved half-shells, and to take on the approximately parallelogramic shape as a back-flow flap for example by internal stress and thus in a springy manner, and thus to be brought into a flat, for example slightly curved shape by underpressure.

FIG. 14 shows a back-flow flap (8, 9, 10), in particular an active back-flow flap (8, 9, 10) according to the invention, which is connected to a fluid/gas connection (18) between the upper wing face and lower wing face to improve the braking effect. This has the result that the higher pressure from the lower face is compensated at least in part by the lower pressure of the upper wing/profile face, and the lift is thus greatly reduced. This effect is known in Schempp-Hirth braking flaps, which can be attached to the upper and lower wing face and require complete penetration of the wing.

This aforementioned penetration majorly weakens the wing construction, and has to be compensated using complex and expensive construction technology.

Using the active back-flow flap (8, 9, 10) according to the invention, this major drawback can be prevented in that this fluid/gas connection (18) becomes closed (inactive) as a result of the closed back-flow flap (8, 9, 10), and is activated and makes this advantage exploitable only when the backflow flap (8, 9, 10) is activated. In particular fluid/gas connections (18) configured/arranged as a point lead to minimal weakening of the wing construction. Like the back-flow flap (8, 9, 10) itself, these may be arranged as desired, for example in one or more rows below the closed back-flow flap (8, 9, 10). It is also conceivable that the upper profile face is connected to the trailing profile edge (6) by the fluid/gas connection (18). Preferably, in this case a base element (23) fixed to the trailing edge can be used so as to fix the back-flow flap (4, 8, 9, 10) to a joint or resilient hinge (7, 11) in an articulated manner and also so as to provide a large fixing surface with reinforcement properties at the trailing edge. The fluid/gas connections (18) to be attached in the wing could optionally also be marked/attached therein. This fluid/gas connection (18) may also merely lead from the upper wing face into the hollow wing interior, which is optionally connected to a central opening at another point towards the outside, for example the tip, so as to achieve this pressure compensation effect.

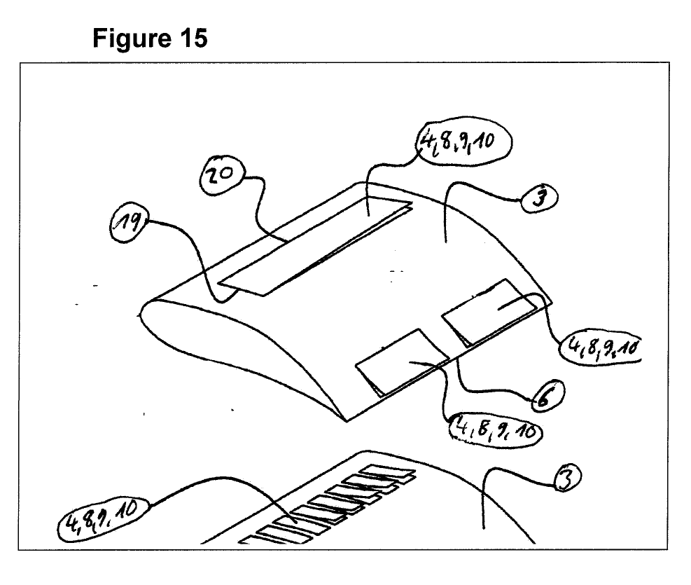

FIG. 15 shows the example arrangements/positions of the passive and/or active back-flow flaps (4, 8, 9, 10).

In particular the arrangement above or below in the region of the trailing profile edge (6) to increase the lift and the region of the greatest profile thickness (19), particularly for use with a braking effect/lift reduction/increase in resistance, is advantageous. The passive and/or active back-flow flap (4, 8, 9, 10) may also be integrated into the wing profile (3) in such a way that no flap transition (20) in the form of a diagonal or curve is required (low in/free from gaps).

Because of the low thickness of the passive and/or active back-flow flaps (4, 8, 9, 10), integration is usually feasible without significant penetration of the shell/sandwich structure of the wing (3). The flap transition (20) is preferably implemented aerodynamically advantageously using a resilient, slightly curved plastics material strip.

A novel method of a safety system for preventing dangerous operating states and/or of a resource efficiency/energy efficiency improvement system for influencing the flow of an aerodynamic or hydrodynamic body (3), in particular of installations equipped with aerofoils (for example energy generating systems or aeroplanes), following the principle of a back-flow flap (4, 8, 9, 10) is further made possible, in which there are
a) a fluid flow speed measurement in the environment of the wing and/or
b) a direct and/or indirect wing load measurement,
c) so as thus to control and/or regulate an active and/or passive flow influence of the aerodynamic or hydrodynamic body (3), in particular the wing (3).

A novel method of a safety system for preventing dangerous operating states and/or of a resource efficiency/energy efficiency improvement system for influencing the flow of an aerodynamic or hydrodynamic body (3), in particular of installations equipped with aerofoils (for example energy generating systems or aeroplanes), following the principle of a back-flow flap (4, 8, 9, 10) is further made possible, in which there are
a) a fluid flow speed measurement in the environment of the wing and/or
b) a direct and/or indirect wing load measurement,
c) so as thus to control and/or regulate an active and/or passive flow influence. This can take place for example by way of back-flow flaps and/or spoilers/flaps and/or braking systems (for example braking parachutes and/or braking flaps and/or overpressure and underpressure compensation systems) of the wing (3).

A novel method of a safety system for preventing dangerous operating states and/or of a resource efficiency/energy efficiency improvement system for influencing the flow of an aerodynamic or hydrodynamic body (3), in particular of installations equipped with aerofoils (for example energy generating systems or aeroplanes), following the principle of a back-flow flap (4, 8, 9, 10) is further made possible, in which there are
a) a fluid flow speed measurement in the environment of the wing and/or
b) a direct and/or indirect wing load measurement,
c) measurement systems for detecting further dangerous operating states,
d) so as thus to control and/or regulate an active and/or passive flow influence by way of back-flow flaps and/or spoilers/flaps and/or braking systems (braking parachutes and/or braking flaps and/or overpressure and underpressure compensation systems) of the wing (3).

Method of a safety system for preventing dangerous operating states and/or of a resource efficiency improvement system for influencing the flow of an aerodynamic or hydrodynamic body ( ) in particular of installations equipped with aerofoils (for example energy generating systems or aeroplanes), following the principle of a back-flow flap (4), characterised in that there are
a) a fluid flow speed measurement in the environment of the wing by means of at least one camera system and/or
b) a direct and/or indirect wing load measurement by means of at least one camera system per wing (3),
c) measurement systems for detecting further dangerous operating states,
d) so as thus to control and/or regulate an active and/or passive flow influence by way of back-flow flaps and/or spoilers/flaps and/or braking systems (braking parachutes and/or braking flaps and/or overpressure and underpressure compensation systems) of the wing (3).

Dangerous operating states may be faults or other relevant influences on the installation. The following example measurement systems for detecting further example dangerous operating states can be used:
1) Load state of the wing through deformation (bending, twisting, oscillations, material stresses, flap status/state, underpressure and overpressure measurement):
   a) strain measurement using strain gauges or optical fibres
   b) deformation measurement using camera and/or laser spots/lines/grids and/or markings, for example spots/components/prisms for surface area measurement, distance measurement
   c) oscillation and surface wave measurement
   d) force measurement using force sensors
   e) pressure sensors
2) weathering state: icing up, snow, rain, fog, hail, turbulence, temperature, air humidity/dew point, clouds/cloud height, solar radiation
   a) camera measurement systems, in particular intelligent cameras or webcams
   b) mechanical and electronic wind and/or weather measurement systems (lidar, sodar, radar, ultrasound, underpressure nozzles comprising pressure sensors, mechanical, among others)
3) installation and/or wing state or damage, soiling, wear, ageing:
   a) ultrasound measurement systems
   b) radar measurement systems
   c) cameras, in particular including IR cameras and/or laser measurement systems for surface area measurement
   d) oscillation measurement systems
   e) surface wave measurement systems

The measurement systems may in particular be held and/or moved, in particular along the wing/rotor (3), by fixed and/or movable/moving mountings (for example wing scissors (or pincers), winglets, wires, bars, profiles) on the wing/rotor (3) and/or on the spinner (rotor nose) and/or mast and/or base. The movement may be carried out using conventional actuators.

The speed measurement of the fluid/air/wind can be taken directly, for example directly at or at a small distance from (in the environment of) the wing. Preferably, however, the measurement is taken at least at one point of the wind generator and/or wind power station, particularly preferably at least at 3 points of the wind power station.

The positions of the back-flow flaps may also be determined using one of these measurement systems, and dangerous states may also be derived from these, on the basis of which warnings may be passed on. Generally, mechanically visual and/or wired and/or wireless communication may be used for this purpose.

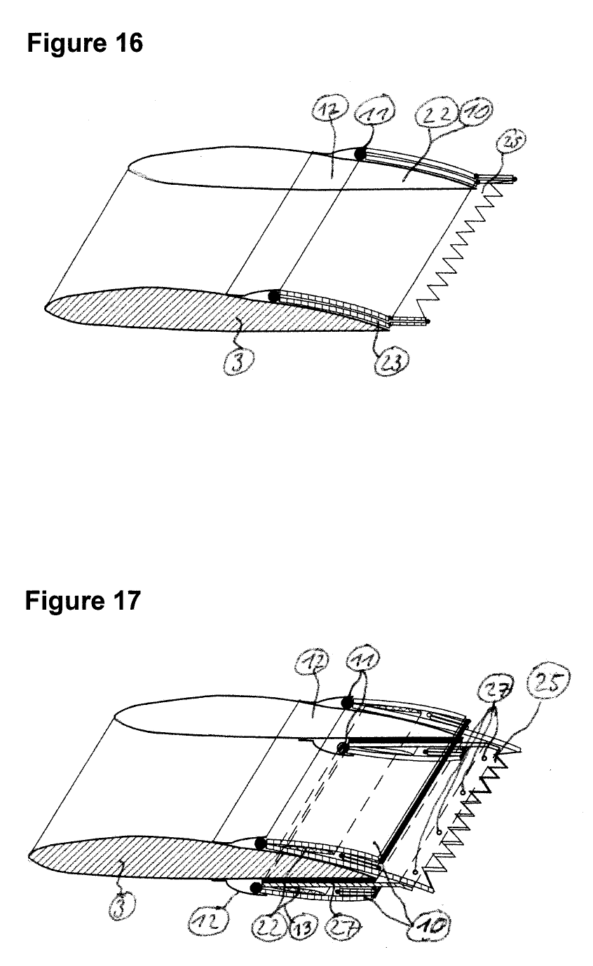

FIG. 16 shows a preferred embodiment of the active parallelogram back-flow flap (10) on the upper wing face, for improving the noise reduction by prior art methods using a noise-reducing lift element (25) comprising a base element (23) for fixing to the wing (3). The base element (23) is connected to the parallelogram back-flow flap (10), which in this example is toothed, via a resilient hinge (11). The parallelogram back-flow flap (10) is configured in such a way that it itself acts as an actuator, in that it contains a foldable hose which has precisely the contours of the actuator (folded parallelogram hose). In this context, the non-equilateral parallelogram is folded outwards.

FIG. 17 shows an active parallelogram back-flow flap (10) on the upper and lower wing face comprising an integrated hose (13), for improving the noise reduction by prior art methods using a noise-reducing base element (25, 23), which in this example is V-shaped and is slid onto the trailing edge of the wing and subsequently attached/fixed. It may also be fixed using spring force from the base element (23) and/or optionally frictional forces and/or adhesive forces.

Moreover, the base element (23) can be fixed using mechanically known detachable and non-detachable means (27) such as rivets and screws, and using a high-performance hook and loop fastener.

Moreover, the boundary component (5) of the parallelogram back-flow flap (10) itself takes on the excursion limitation (26) of the parallelogram back-flow flap (10).

A hose (13) located therein serves as an actuator element (22). In this context, the fixing means (27) of the base element (23) is a planar adhesive connection, on each of the upper and lower face, for the wing (3).

FIG. 18 shows an active parallelogram back-flow flap (10) on the lower wing face and a simplest possible variant comprising a hose (8) and combined with a prior art back-flow flap (4) on the upper wing face, comprising a noise-reducing base element (25, 23).

In particular the simplest possible variant on the upper face of the wing (3) comprising an actuator element (22) in the form of a folded hose (13), which is fixed to a V-shaped base element (23) which is itself fixed to the wing (3), is of a very simple construction. The back-flow flap (4) is movably fixed to a hinge (11, 7) on the hose or on the base element (23). The flap may optionally operate as a combined active and passive flap, depending on how and where the back-flow flap is fixed.

FIG. 19 shows a passive and active triangular back-flow flap (8) (in the activated position) comprising an oscillation attenuation system based on mass inertia on the upper wing face (only in one direction), comprising V-shaped base elements (23) on the wing tip and trailing wing edge.

The aim is to compensate/attenuate in particular accelerations due to wind gusts (storm control) at higher wind speeds of V_{Nominal} upwards (region for improvement C+D) in the plane of the profile (3) perpendicular to the profile chord. This takes place in that a lever (29) is mounted on a joint (7) on the base element (23) of the wing tip, and a mass inertia element (28) in the form of a weight, preferably an aerodynamically shaped steel or lead weight, is fixed to this lever (29). Further, the simple triangular back-flow flap (8) shown here is likewise connected to a lever (29), in such a way that by way of 2 further levers (29) kinematics equivalent to a movable parallelogram lever system are brought about. If the wing (3) is now moved/accelerated towards the upper profile face, the mass inertia element (28) (initial position in the neutral position in the direction of the profile chord) is now left behind in spatial position as a result of the mass inertia, and the lever (29) fixed thereto moves towards the lower profile face as shown here.

By way of the lever mechanism (29), the movement of the mass inertia element (28) is transmitted to the triangular back-flow flap (8), in such a way that said flap moves upwards and as a result there is a braking effect as a braking flap having lift reduction. This lift reduction leads to a corresponding counter movement of the wing (3), which has been generated by the wind gust. This principle can naturally also additionally be used on the opposite side.

This very simple principle is self-regulating (optionally using a return spring mechanism) and can also be retrofitted in combination with the base elements (23). Naturally, a solution can also be integrated directly into a new wind turbine in this manner.

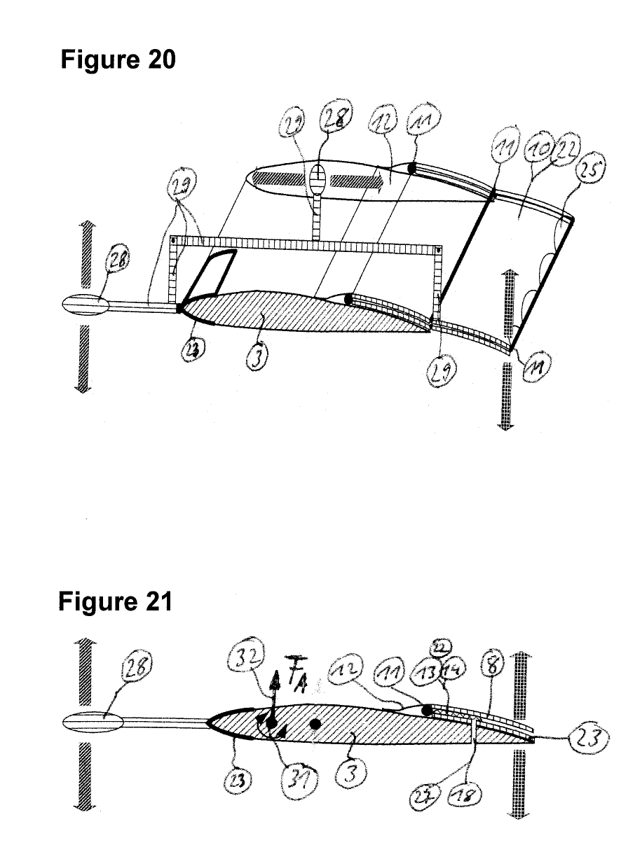

FIG. 20 shows a passive and active parallelogram back-flow flap (8) protruding beyond the trailing profile edge comprising an oscillation attenuation system based on mass inertia on the upper wing face (in both directions), comprising base elements (23) on the wing tip and trailing wing edge.

The aim is to compensate/attenuate in particular accelerations due to wind gusts (storm control) at higher wind speeds of V_{Nominal} upwards (region for improvement C+D) in the plane of the profile (3) perpendicular to the profile chord (as in FIG. 19) and additionally yaw oscillations having a direction approximately within the profile chord.

This takes place, as in FIG. 19, in that a lever (29) is mounted on a joint (7) on the base element (23) of the wing tip, and a mass inertia element (28) in the form of a weight, preferably an aerodynamically shaped steel or lead weight, is fixed to this lever (29). Further, the parallelogram back-flow flap (10) shown here is likewise connected to a lever (29), in such a way that by way of 2 further levers (29) kinematics equivalent to a movable parallelogram lever system are brought about. If the wing (3) is now moved/accelerated towards the upper profile face, the mass inertia element (28) (initial position in the neutral position in the direction of the profile chord) is now left behind in spatial position as a result of the mass inertia, and the lever (29) fixed thereto moves towards the lower profile face as shown here. By way of the lever mechanism (29), the movement of the mass inertia element (28) is transmitted to the parallelogram back-flow flap (10), in such a way that said flap moves upwards and as a result there is a braking effect as a braking flap having lift reduction. This lift reduction leads to a corresponding counter movement of the wing (3), which has been generated by the wind gust. For an appropriate configuration of the joints and of the parallelogram back-flow flap (10), this also works in the opposite direction of acceleration due to the wind gust.

To compensate the yaw oscillations, a mass inertia element (28) is also fixed to the long lever (29), and remains behind relative to the trailing profile edge in the event of an acceleration which moves on ahead in the direction of the profile tip in the direction of the mass inertia, and thus moves the parallelogram back-flow flap (10) (part behind the trailing profile edge) downwards and thus generates more lift and also more profile resistance. This results in a counter movement to the originating wind gust and in an attenuation of this yaw movement/acceleration. Naturally, this system can also be used individually or else only in particular wing regions.

This very simple principle is self-regulating (optionally with a return spring mechanism) and can also be retrofitted in combination with the base elements (23). Naturally, a solution can also be integrated directly into a new wind turbine in this manner.

The variants shown in FIGS. 19 and 20 of the back-flow flaps according to the invention may naturally also be combined with a normal rudder/flap (optionally additionally attached), in such a way that this is of benefit in new wind turbines. The variants can also be combined with an active actuator element, in such a way that passive and active activation can take place.

FIG. 21 shows a passive and active parallelogram back-flow flap (10) on a rotatably mounted wing or wing part comprising an oscillation attenuation system based on mass inertia on the upper wing face (only in one direction), comprising base elements (23) on the wing tip and trailing wing edge.

The aim is to compensate/attenuate in particular accelerations due to wind gusts (storm control) at higher wind speeds of V_{Nominal} upwards (region for improvement C+D) in the plane of the profile (3) perpendicular to the profile chord (as in FIG. 19).

In this context, the operation of the shown active triangular back-flow flap (8) (in the non-activated position) operates entirely conventionally.

To compensate these oscillations, a mass inertia element (28) is fixed to the lever (29). If the wing (3) is now moved/accelerated towards the upper profile face, the mass inertia element (28) (initial position in the neutral position in the direction of the profile chord) is now left behind in spatial position as a result of the mass inertia, and the wing or wing part mounted here for example at the torque zero of the profile/wing (31) experiences a torque due to the mass inertia element (28) and thus is likewise left behind somewhat, leading to a reduction in angle of attack and thus a reduction in lift. This thus acts counter to the wind gust in an attenuating/compensating manner.

As a result of the mounting at the torque zero of the profile/wing (31), the lift forces F_{L} (32) at this point are unaffected.

In principle, in this way a type of outboard wing can also additionally be actively activated/actuated/regulated by way of an additional actuator, in particular an actuator according to the invention.

This is in particular a beneficial solution for new wind turbines having long and in any case divided rotor blades (transportation advantage of shorter rotor blade parts).

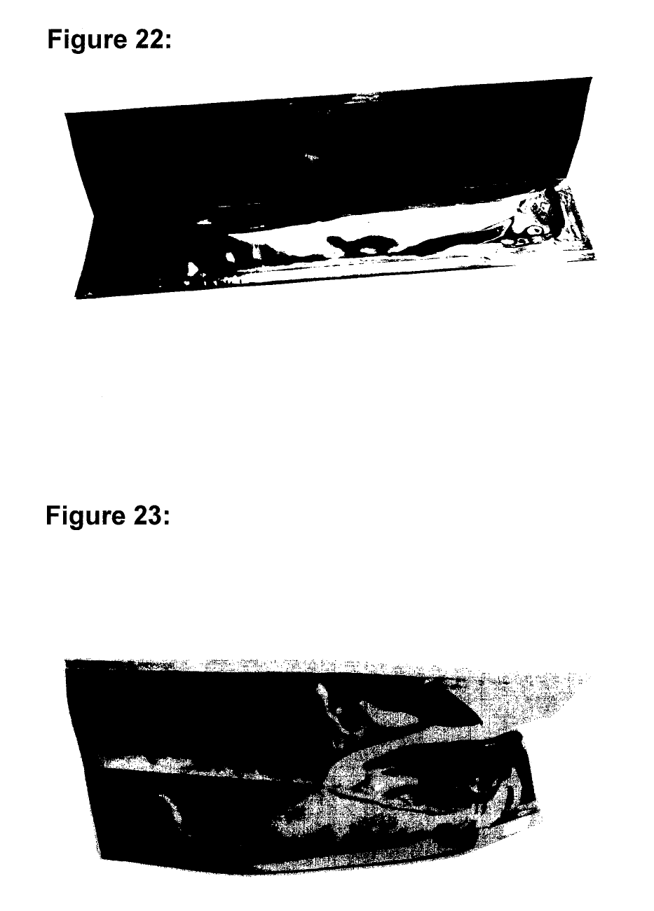

FIG. 22 shows an end piece of a folded hose and it is shown, by way of example using the example of the base/end piece of a sachet, how a folded hose can be effectively sealed, for example by friction welding, in such a way that it durably joins in with the folding and unfolding process under overpressure and if applicable underpressure.

A hose made of composite material of aluminium and plastics material film or of plastics material films differing from one another is preferred.

FIG. 23 shows an end piece of an unfolded hose and it is shown, by way of example using the example of the base/end piece of a sachet, how a folded hose can be effectively sealed, for example by friction welding, in such a way that it durably joins in with the folding and unfolding process under overpressure and if applicable underpressure.

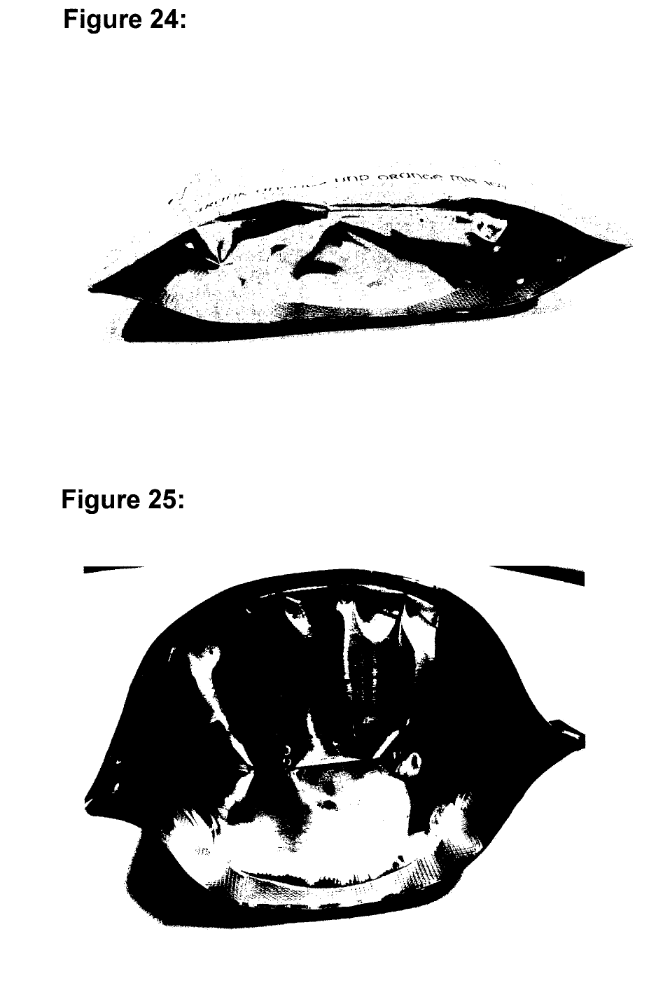

FIG. 24 shows the end piece of a folded hose and it is shown, by way of example using the example of the base/end piece of a foldable drink container comprising a curved base, how a folded hose can be effectively sealed, for example by friction welding, in such a way that it durably joins in with the folding and unfolding process under overpressure and if applicable underpressure.

FIG. 25 shows the end piece of an unfolded hose and it is shown, by way of example using the example of the base/end piece of a foldable drink container comprising a curved base, how a folded hose can be effectively sealed, for example by friction welding, in such a way that it durably joins in with the folding and unfolding process under overpressure and if applicable underpressure.

An element (optionally comprising a curved base) configured as a plug of any desired shape, which can subsequently be durably sealed for example by gluing, shrinking, welding among others, may also be used as a hose end. In this way, a plug can also be configured conically or in another mechanical way so as to take on the durable sealing function thereof. (Optionally, the connecting piece may also be attached thereto.) This plug may also be aerodynamically shaped so as to generate a small or large amount of turbulence. Likewise, a control and/or pressure regulation valve may be attached directly thereto.

The variants shown in FIGS. 1 to 25, in particular 22 to 25, may also be combined with the magnetorheological actuator type. For this purpose, an element which generates a magnetic field is preferably in the direct vicinity of the hose (13) so as to act thereon. The magnetorheological fluid or polymer is located in the hose (13), and thus activates the fluid and thus the actuator element (22) when the electromagnetic field is applied. It has very short reaction times, in the range of fractions of seconds. The element which generates a magnetic field is preferably attached to and/or integrated into the hose (13).

A fluid flow speed measurement in the environment of the wing may be taken by means of pneumatic and/or electric pressure probes and/or acceleration sensors (in particular for wind gusts) fixed to the outboard wing at a distance, optionally on a base element (23).

For the use of back-flow flaps in the field of aviation and wind energy, a perforated film, preferably of plastics material, has been found to be expedient. This has a thickness of 0.1 to 1 mm and has at least 5, preferably 10 holes/slits per cm², particularly preferably having at least 20 holes per cm².

In this embodiment, at low angles of attack (for example 2—approximately 12 degrees) this leads to the profile curving (the film curving up with slight fluttering) in the region of the back-flow flap as a result of the resilient perforated back-flow flap. Only when the angle of attack increases further does the back-flow flap react in a known manner by rising.

This leads to good aerodynamic properties of the aerofoil/aeroplane. In the field of aviation, this has the result that an aeroplane obtains extremely smooth flight properties and for example the control stick can be pulled right down without the aeroplane swerving or spinning (the flow is maintained), and instead it flies downwards with a slightly higher rate of descent. In this case of wind energy, this leads to improvements in lift/power/yield. Lightweight reinforcements for reducing fluttering and if applicable for angle delimitation can be used in this context.

The following property rights and literature are also part of the present application and can be combined freely with the content thereof:
DE 102010041111 A1
U.S. Pat. No. 7,293,959 B2
DE 102012000431 A1
JP 2004183640
and the literature represented as prior art.

### DESCRIPTION

### Technical Field of the Invention

Device of a hydraulic and/or pneumatic and/or magnetorheological actuator (2) without a piston for generating a 2-dimensional actuator movement (11) and actuator force, preferably a rotational movement and a torque.

The invention relates in particular to a device of a hydraulic and/or pneumatic and/or magnetorheological actuator (2) without a piston for generating a 2-dimensional actuator movement (11) and actuator force, preferably a rotational movement and a torque, having a very simple construction, which makes a good force action/torque action possible

This makes a compact construction possible and leads to an improvement in resource and material efficiency in this field. In this context, the capacity for retrofitting is particularly simple in a wide range of applications.

### Prior Art

DLR hand, marketed by Schunck

Airic's Arm, from Festo

Exohand, from Festo

xx

xx

xx

### OBJECT OF THE INVENTION

An object of the invention is to improve the energy efficiency of a hydraulic and/or pneumatic and/or magnetorheological actuator (2) without a piston, in particular by way of a very compact construction and thus an application-optimised construction and size, to generate a limited rotational movement, using a novel configuration, in the form of a for example movable parallelogram as an actuator.

A further object of the invention is simultaneously to use this actuator according to the invention as a safety-related device in that it can be operated with at least single redundancy and optionally with diversity.

Further, with an appropriate configuration of for example pneumatic or magnetorheological actuation, some attenuation of the movement or of oscillations can be made possible.

If a plurality of actuators according to the invention are used, such as at least 2 in number, a 3-dimensional movement can also be made possible, such as occurs in robot arms or artificial limbs.

Further, movable systems of this type can be coupled and used industrially in combination with known sensors and control and/or regulation systems.

### Solution

An object of the invention is to provide an energy-efficient solution which is highly reliable in terms of safety by way of a novel and compact configuration of a hydraulic and/or pneumatic and/or magnetorheological actuator.

### DESCRIPTION OF THE INVENTION

### Field of Use

The devices and methods according to the invention can be used in all technical devices on land, on water and underwater and in the air. Example applications are set out in the claims and in the description.

In the following, the operation and the advantages and fields of application thereof are set out in examples in the drawings.

FIG. 1 shows a device according to the invention of a hydraulic and/or pneumatic and/or magnetorheological actuator (2) without a piston for generating a 2-dimensional actuator movement (11) and actuator force, preferably a rotational movement and a torque, which is here folded into the rest position.

However, in other applications this may equally also be an operating position, this being a matter of definitions.

This actuator (2) in the folded state consists of at least one face/wall (5, 6, 7), preferably of 3 (triangular shape), particularly preferably 4 (parallelogram shape), even more preferably of an even number of faces/walls (5, 6, 7), and at least one fluid-fillable space (10), in particular a foldable actuator (2), and of at least one joint element (9), preferably the foldable hose (10) and/or actuator (2).

FIG. 1 shows a parallelogram actuator which, because it is movable through 90/180 angular degrees, can preferably be used in technical applications.

FIG. 2 shows that when a fluid is applied to the fluid-filled space/hose (10), through an opening not shown here, the expansion/filling thereof can cause the actuator (2) to rise/unfold under the pressure in the fluid-filled space/hose (10) by means of the rising movement (11) thus generated.

The entire actuator (2) is thus, in a possible first position, for example a folded-up rest position, a flat outer contour similar to a preferably thin plate and, in a second possible and preferred position, for example twisted through 90 angular degrees, in an unfolded operating position.

In this context, this actuator (2) and/or the attached device (14) form for example a shape of a polygonal cross section outer contour, for example triangular, square, parallelogramic, hexagonal, polygonal, scissor-shaped, as is shown in FIG. 2. In this context, a plurality of actuators of this type arranged directly against one another form a honeycomb structure of these polygons.

This actuator (2) is arranged in such a way that this actuator (2) can be moved and/or positioned, at least between these two positions, in the form of a rotational movement about at least one, preferably at least 3, more preferably at least 4 joint elements (9). These joint elements (9) can be formed by known hinges, strips, wovens, adhesives, hoses, films, other resilient materials or the actuator itself (for example by 3D printing). A preferred embodiment comprises the same number of joint elements (9) as the number of faces/walls (6, 7, 8); particularly preferably, the joint elements (9) are formed from one component, preferably a hose component (10).

The device according to the invention comprises a straight or curved and/or reinforced face/wall (6, 7, 8), for example by way of macro-, micro-, nano-structuring, for example by means of curved structures made of metals or plastics materials, and/or reinforcements, for example by way of fibre composite plastics materials, such as GFRP CFRP and/or nanoparticle reinforcements and/or surfaces such as carbon nanofibres. Devices are particularly preferred which are characterised in that the face/wall (6, 7, 8) is at least as rigid as a straight control plate without reinforcements made of 1 mm glass-fibre-reinforced plastics material (GFRP).

The front ends of the actuator (2) and/or hose and/or sheath (10) are configured by way of a curved base and/or fold structure and/or pressed flat and thus sealed in a fluid-tight manner and/or preferably planar in the folded state of the actuator (2).

The fluid supply, not shown here, can be configured specifically in each individual case, and thus be configured from any direction of the actuator. An unmovable configuration from the direction of and/or through the base body is particularly preferred.

The fluid supply may also be provided through an actuator or fixed internally or externally thereto.

In the example shown in FIGS. 1 and 2, a workpiece (4), which is moved by a base movement (12) in the X-direction of the coordinate system (5), and re-oriented in the Y-direction of the coordinate system by an orientation movement (13) generated by the actuator (2) is re-oriented in this direction, without the base movement (12) coming to a standstill on the support plate (3) for example on a roller belt or conveyor belt. This can thus be used for example in a sorting station or workpiece switch, for example in packaging systems or the like.

By contrast with FIGS. 1 and 2, FIGS. 3 and 4 show a likewise preferred embodiment for lifting loads. In this context, the workpiece (4) is used by a device for orientating and lifting (14), additionally fixed on the actuator (2), to make the lifting movement and onward movement (18) of the workpiece (4) possible.

Lifting devices of this type may be lifting tables, lifting stages and the like such as are also used for example in heavy goods vehicles or loading ramps in the field of loading.

Devices of this type may also be used on desks for height adjustment, including for example in a single or multiple scissor configuration for retrofitted installation. Adjustment devices of this type can be activated using a very low pressure by means of a slow upwards movement by for example a cost-effective and quiet overpressure diaphragm pump. In this context, the downward movement can take place under gravity by evacuating the actuator of air using a hand-operated valve. Naturally, this can also take place by switching to negative pressure in the case of an overpressure/underpressure pump.

Generally, the rotational movement (11) and force generation can take place by way of compressed air overpressure and/or underpressure, preferably overpressure and/or underpressure stores (25, 26), for example compressed air/CO₂ cartridges, for example for safety systems such as the emergency opening of escape doors, emergency closing of ventilation fire shutters.

The actuator (2) may also be moved towards at least one of the two positions in combination with a return movement, for example from spring force, gravity, manual force, external pressure/flow pressure and/or overpressure/underpressure, including through appropriate nozzles, centrifugal force (for example in rotors).

For technical applications of this type, it is advantageous for the generated force to act in proportion to the effective actuator area and the pneumatic and/or hydraulic fluid pressure in the direction of the rotational movement (11), and thus to exert a torque via one or more faces/walls (6, 7, 8) and/or devices/lever arms (14). This force/torque may be of a linear and of a non-linear nature.

To convert the rotational movement to a linear movement, known technologies, such as a connecting rod, or particularly preferably a crosshead and a connecting rod, may be used.

FIGS. 5 and 6 show a safety-related device in the form of a device (19) of a frame for flood protection comprising an actuator (2) mounted thereon. This shown device is for example raised in part using the actuator (2) and subsequently finished completely by hand. A multi-wall arrangement comprising at least one actuator (2) is particularly advantageous, in particular for increased safety, in particular for use in high-reliability and/or safety-related systems, and/or an oscillation attenuation function.

It is particularly advantageous and simple for the joint(s) (9) to be formed by the actuator (2) itself and for this actuator (2) to be radially deformable in the form of at least one at least 2-dimensionally radially deformable and/or resilient hose/sheath (10), particularly preferably at least 2 hoses/sheaths placed one inside the other, it being possible for the face(s)/wall(s) (6, 7, 8) to be arranged between them and/or externally and/or internally. In this context, resilient means 3-dimensionally deformable. Depending on the level of forces and torques and the operation of the actuator (2), the aforementioned conventional hinges may also additionally be usable.

FIGS. 7 and 8 show by way of example an emergency tunnel and rescue system (22), preferably for motor vehicle tunnels or other buildings for evacuating people (23).

The problem with known technologies is the space requirement in non-emergency situations (free hard shoulders) and the air supply to the people in case of fire in the event of an accident, which is achieved by the device according to the invention.

In FIG. 7, the double parallelogram rescue tunnel (22) is stored stationary, fixed to the tunnel wall in the folded/folded-up state, until it is to be used in the use situation.

For example, people or conventional fire alarm systems trigger the rescue system in this case.

In FIG. 8, the actuator system (2), triggered/unfolded/folded out by for example gravity or spring force, of the parallelogram rescue tunnel (22) is ready for use so as to receive people therein and make a safe rescue possible.

In this context, it is necessary for a sufficient air supply into the rescue tunnel (22) to be provided, and this can take place for example via the fluid-filled hose (10), via air inlet valves not shown here, since smoke can penetrate into the rescue tunnel (22) as a result of people (23) entering through doors not shown here. Alternatively or in addition, the rescue tunnel (22) consisting of fire-retardant material can also be directly ventilated and if appropriate evacuated of air towards the outside by overpressure valves.

After use and appropriate function control, the rescue tunnel (22) can be reused in that it is brought back into the rest/stand-by position by any desired actuator, preferably the actuator according to the invention, for example by negative pressure.

The arrangements in FIGS. 9 and 10 of a plurality of actuators (2) of this type against one another, for example 2 actuators (2) interconnected rotated through 90 angular degrees, make 2- and/or 3-dimensional movement possible.

FIG. 9 shows by way of example an actuator (2) arranged doubled-up and comprising the likewise doubled-up and separated fluid-filled spaces/hoses (10) for generating a rising/unfolding rotational movement of the actuator (11) spanning 180 angular degrees. The two actuators (2) are interconnected via joint elements (9). The two actuators (2) are fixed via the base face (6) to the base body (1) and are each supplied with fluid via at least 1 hole via pipelines (27). Via these pipelines (27), the fluid supply is controlled or regulated by at least 1 directional valve or control valve (24) and the fluid is supplied by the overpressure (25) and underpressure (26) store.

These are supplied by a compressor (30), which can ideally generate overpressure and underpressure. Via a control or regulation system (29), the directional valve or control valve (24) can be controlled or be regulated by means of additional directional sensors or force sensors (not shown).

FIG. 10 shows by way of example an actuator (2) arranged doubled-up and comprising the also doubled-up but not separated fluid-filled spaces/hoses (10) for generating a rising/unfolding rotational movement of the actuator (11) spanning 180 angular degrees. The two actuators are interconnected via joint elements (9). The two actuators (2) are fixed via the base face (6) to the base body (1) and are each supplied with fluid via at least 1 hole via pipelines (27). Via these pipelines, the fluid supply is controlled or regulated by at least 1 directional valve or control valve (24) and the fluid is supplied by the overpressure (25) and underpressure (26) store.

These are supplied by a compressor (30), which can ideally generate overpressure and underpressure. Via a control or regulation system (29), the directional valve or control valve (24) can be controlled or be regulated by means of additional directional sensors or force sensors (not shown).

The arrangement of more than 2 actuators (2) is particularly preferred; this makes it possible for this arrangement to unfold as far as approximately 360 angular degrees, and this then has the appearance of a honeycomb structure.

FIG. 11 shows, as an example of a base body (1), an aerofoil comprising a configuration which is very simple in accordance with the invention in a scissor-shaped formation. The scissor shape is formed by the base face (6) and the side face (7) of the actuator (2) and a fluid-fillable space/hose (10) located in-between. This arrangement makes possible active and/or passive use of the flap/side face (7) for advantageously aerodynamically influencing the flow on the aerofoil, for improving the energy efficiency and/or storm safety. Systems of this type may in particular also be retrofittable.

FIG. 12 shows, as an example of a base body (1), a trailing edge of an aerofoil comprising a formation which is also very simple in accordance with the invention in a triangular configuration. The triangle shape is formed by the base face (6) and the side faces (7) of the actuator (2) and a fluid-fillable space/hose (10) located in-between. This arrangement differs from the arrangement of FIG. 11 in that the two side faces (7) attached on the right simultaneously also form an excursion limitation of the actuator (2) or of the left side face (7). Further, FIG. 12 shows a fixing means (31) for attaching the base face (6) of the actuator (2) to the trailing edge of the aerofoil. In this context, the excursion limitation may also merely be formed by ropes, strips, nets or the like. This arrangement likewise makes possible active and/or passive use of the flap/side face (7) for advantageously aerodynamically influencing the flow on the aerofoil, for improving the energy efficiency and/or storm safety. Systems of this type may in particular also be retrofittable.

The devices according to the invention shown in FIGS. 1 to 12 may be used for the 2-dimensional actuator movement (11) for moving and/or exerting force and/or opening and/or closing and/or positioning and/or raising and/or orientating and/or displacing and/or lifting and/or switching components (4) fixed and/or not fixed thereto, for example for use for sorting/switching/limiting the excursion of components (4), production parts, artificial moved joints and hands and feet for robots/humans, machines, actuators (2), measurement systems, buildings, protective sheaths for storm protection, automobile components (4) such as the steering system, folding top, door opener/closer, bumper, airbag, parking aids, mirror adjustment, windscreen wipers, headlights, containers, ducts, pumps, sheaths, flaps, levers, locks, doors, windows, safety systems, escape doors, ventilation fire shutters, tables, chairs, walls, clamping, vice, machine actuator (2) for tool change or machine movement axes, ramp such as lifting ramp and lifting stage and loading stage, theatre stage, lift, pivot arm, sorting stops, guide elements, flood protection elements, escape tunnels, steering systems, undercarriages, bonnets, cranes, bridges, presses and thermoforming devices, protection and escape tunnels, flood protection barriers, protective sheaths such as folding vehicle tops, ice removal systems on heavy goods vehicle canvases, building protective sheaths, protection systems such as collision protection optionally with explosive fluid gas pressure generation, for example airbag, bumper, engine bonnet, back-flow flaps and/or braking flaps on vehicles, in particular wings and tail units of aeroplanes, back-flow flaps and/or braking flaps on rotor blades of power generating systems such as wind turbines, terminals and plug-in connections of fluids, energy, signals, or similar components (4), or itself takes on at least in part a function of said aforementioned components (4).

Further, a method of a hydraulic and/or pneumatic and/or magnetorheological actuator (2) without a piston, for generating a 2- or 3-dimensional actuator (11) movement and force, is provided in which
a) the entire actuator (2) takes on a possible first position, for example a folded-up rest position, preferably a low-pressure position, and
b) said actuator is moved into a second possible position, for example removed by 90 angular degrees, a folded-out/unfolded working position, by a rotational movement (11) generated for example by overpressure.

Further, the 2-dimensional actuator movement, in particular a rotational movement (11), of up to approximately 90 angular degrees, particularly preferably up to approximately 180 angular degrees, may bring about the at least 1-dimensional movement and/or gripping of components (4) such as technological devices of any type.

Moreover, a method is provided which provides the arrangement of a plurality of actuators (2) of this type for a 2- or 3-dimensional movement (11) of the entire actuator (2) and the components (4) and/or devices (19) to be moved, for example in artificial hands, robot arms or artificial limbs/prostheses for humans and animals.

Further, a method is disclosed for manufacturing the parallelogram actuator (2) according to the invention, which can be manufactured in the following steps:
a) producing the faces/walls (6, 7, 8) to appropriate dimensions
b) producing one or more hose(s)/sheath(s) (10), made to size and comprising a fluid supply, by cutting to length and/or vulcanising and/or welding and/or gluing and/or sealing and/or mechanical sealing
c) attaching the faces/walls to at least one hose/sheath (10), made to size and comprising a fluid supply, by gluing and/or sealing and/or riveting and/or vulcanising and/or screwing and/or hooking (hook and loop fastener) and/or shrinking a shrink-on film/hose (10) and/or by other mechanical methods
d) If it is necessary to provide two/three walls:
   covering the actuator (2) made thus far with an outer sheath (10) comprising a fluid supply passage by the aforementioned methods and/or shrinking a shrink-on film/hose (10) and optionally attaching further faces/walls (6, 7, 8) by said methods and/or
e) using a previously produced double-wall hose (10) in step a)
f) If required, after each process step, the actuator (2) can be tested for tightness using overpressure and underpressure and optionally subsequently filled with a process fluid/element, such as the magnetorheological liquid/polymer.

Further, a second method is disclosed for manufacturing the parallelogram actuator (2) according to the invention, which can be manufactured in the following steps:
a) producing the faces/walls (6, 7, 8) to appropriate dimensions
b) producing one or more precursors of the hose(s)/sheath(s) (10), made to size and comprising a fluid supply, by cutting to length and/or vulcanising and/or welding and/or gluing and/or mechanical sealing
c) attaching the faces/walls to at least one planar precursor of the hose/sheath (10), comprising a fluid supply, by gluing and/or sealing and/or riveting and/or vulcanising and/or screwing and/or hooking (hook and loop fastener) and/or shrinking a shrink-on film/hose (10) and/or by other mechanical methods
d) sealing one or more planar precursors of the hose(s)/sheath (s) (10), made to size and comprising a fluid supply, by cutting to length and/or vulcanising and/or welding and/or gluing and/or sealing and/or mechanical sealing
e) If it is necessary to provide two/three walls:
   covering the actuator (2) made thus far with an outer sheath (10) comprising a fluid supply passage by the aforementioned methods and/or shrinking a shrink-on film/hose (10) and optionally attaching further faces/walls (6, 7, 8) by said methods and/or
f) using a previously produced double-wall hose (10) in step a)
g) If required, after each process step, the actuator (2) can be tested for tightness using overpressure and underpressure and optionally subsequently filled with a process fluid/element, such as the magnetorheological liquid/polymer.

The following property rights and literature are also part of the present application and can be combined freely with the content thereof:

The functional principle is based on the parallelogram (polygon) actuator and/or hose actuator.

In the following, the actuator principle is disclosed.

The actuator is shown in 3 positions, the 0 degree, 45 degree and 90 degree positions.

The basic principle of a joint of a finger comprising 2 members and a multifunctional actuator (MF).

The complete finger in 3 positions is disclosed in greater detail in the following.

It is also possible to use 2 MF actuators in a joint, in which case an overpressure (U) is applied to one and the other, on the opposite face (for example arranged offset by 90 degrees) is evacuated or supplied with an underpressure (U).

The MF actuator may also be arranged precisely on the inner face of the finger joint, in such a way that the primary rotary joint is arranged on the outer face.

Further, the joint may also for example be configured in the form of movably configured plastics material arc hinges from one or more ball joints so as to achieve a high number of movement cycles and a high service life of the actuator.

In this context, parts or the whole of the MF actuator may in particular be manufactured from composite materials consisting of aluminium and plastics material or metal-coated plastics materials or textile-reinforced plastics materials.

Appropriately positionally favourably arranged controlled or regulated valves make it possible to supply the MF actuator in question with overpressure and/or underpressure.

It appears to be particularly favourable to arrange and use the finger (bone) elements as an overpressure/underpressure store/reservoir.

In this case, these reservoirs are further supplied with overpressure/underpressure via an internally attached or externally positioned pipeline, preferably a flexible hose. The finger (bone) elements may also serve merely as a static element and/or pipeline. The actuator may also consist of a polygon which in principle forms a parallelogram but for example contains arc-shaped elements in part which optionally serve as joints and/or resilient hinges.

In further embodiments, the MF actuator may be used merely in the static structure of the parallelogram shape thereof, so as itself to be actuated by a pneumatic or hydraulic cylinder via a lever.

In principle, given appropriate sealing of the piston rod with respect to the MF actuator, the aforementioned embodiment can also be used as an alternative to the MF actuator, for example for controlling flaps of an aeroplane in case of emergency by way of one of the two mentioned variants or other variants comprising a normal pneumatic or hydraulic cylinder.

Further variants comprising a normal pneumatic or hydraulic cylinder are shown with other lever arrangements which may alternatively be used.

The principle of the mechanics of a pneumatic retractable undercarriage comprising a return spring may also be adapted appropriately for model aeroplanes so as to implement a 90 degree movement for an artificial hand or for other mentioned applications. In particular the use of UV-radiation-resistant materials and coatings may be used.

In this way too, an actuator can also be used for closing overhead lockers of aircraft or luggage compartments of automobiles and the like. The actuator may also be combined with magnetorheological liquids or polymers/electrorheological liquids.

If the aforementioned fluids and materials are used, a combination of magnetic material and an electric coil for generating the electromagnetic field may also be used.

A simple rotary element having highly rotatable magnets can also be used to activate the fluids and/or materials and/or the flaps.

Advantageous developments of the invention may be derived from the claims, the description and the drawings. The advantages of features and of combinations of a plurality of features set out in the introduction to the description are merely examples, and may take effect alternatively or cumulatively without the advantages necessarily having to be achieved by embodiments according to the invention.

Further features may be derived from the drawings, in particular the geometries shown and the dimensions of a plurality components relative to one another and the relative arrangement and operative connection thereof. Features of different embodiments of the invention or features of different claims may also be combined in a manner deviating from the selected dependencies of the claims, and is hereby encouraged. This also applies to features which are mentioned in separate drawings or mentioned in the description thereof. These features may also be combined with features of different claims. Likewise, features set out in the claims may be omitted for further embodiments of the invention.

The invention is described in the following by way of examples and drawings, which show the following:

FIG. 1:

Wind turbine potentials for improvement

Wind turbine potential for improvement: A=low wind of V_{StartNew}−Vₛₜₐᵣₜ

Wind turbine potential for improvement: B=low wind of Vₛₜₐᵣₜ−V_{Nominal}

Wind turbine potential for improvement: C=medium wind of V_{Nominal}−V_{MaxNormal}

Wind turbine potential for improvement: D=high wind of V_{MaxNormal}−Vₘₐₓ₃₅ₘ

FIG. 2:

Model wing a: with separated flow; b: the same but with a flap

FIG. 3:

Simulated flow relationships on an aerofoil comprising a back-flow flap

FIG. 4:
a) Wing profile comprising raised triangular back-flow flap (8) having complete shift of the flap region boundary (21)
b) Wing profile comprising raised arc-shaped back-flow flap (8) having complete shift of the flap region boundary
c) Wing profile comprising raised parallelogram back-flow flap (8) having complete shift of the flap region boundary

FIG. 5:
a) Wing profile comprising raised triangular back-flow flap (8) having partial shift of the flap region boundary (21)
b) Wing profile comprising raised arc-shaped back-flow flap (8) having partial shift of the flap region boundary (21)
c) Wing profile comprising raised parallelogram back-flow flap (8) having partial shift of the flap region boundary (21)

FIG. 6:
a) Wing profile comprising closed triangular back-flow flap (8) having complete shift of the flap region boundary (21)
b) Wing profile comprising closed arc-shaped back-flow flap (8) having complete shift of the flap region boundary (21)
c) Wing profile comprising closed parallelogram back-flow flap (8) having complete shift of the flap region boundary (21)

FIG. 7:

Combination of a plurality of back-flow flaps

FIG. 8:

Combination of a plurality of back-flow flaps with actuator

FIG. 9

Prior art back-flow flap (4) combined with a boundary component (5) in the form for example of a balloon or hose or cushion (13)

FIG. 10:

Triangular back-flow flap (8) which has for example a hose (13) incorporated as an active actuator

FIG. 11

Triangular back-flow flap (8) which is completely closed in the three-dimensional configuration thereof so as to be filled with for example air via a fluid/gas connection (18)

FIG. 12

Parallelogram back-flow flap (8) which is completely closed for example in the three-dimensional configuration thereof so as to be filled with for example air via a fluid/gas connection (18)

FIG. 13:

Active back-flow flap (10) which is merely formed by a closed hose pressed flat

FIG. 14:

Active back-flow flap (8, 9, 10) for improving the braking effect comprising a fluid/gas connection (18) between the upper wing face and the lower wing face

FIG. 15:

Example arrangements/positions of the passive and/or active back-flow flaps (4, 8, 9, 10)

FIG. 16:

Active parallelogram back-flow flap (10) on the upper wing face, for improvement comprising a noise-reducing lift element (25) comprising a base element

FIG. 17:

Active parallelogram back-flow flap (10) on the upper and lower wing face having an integrated hose (13), for improvement comprising a noise-reducing base element (25, 23)

FIG. 18:

Active parallelogram back-flow flap (10) on the lower wing face and simplest possible variant comprising a hose (8) and combined with prior art back-flow flap (4) on the upper wing face, comprising a noise-reducing base element (25, 23)

FIG. 19:

Passive and active triangular back-flow flap (8) comprising an oscillation attenuation system based on mass inertia on the upper wing face (only in one direction), comprising V-shaped base elements (23)

FIG. 20

Passive and active parallelogram back-flow flap (8) protruding beyond the trailing profile edge comprising an oscillation attenuation system based on mass inertia on the upper wing face (in both directions), comprising base elements (23)

FIG. 21

Active parallelogram back-flow flap (10) on a rotatably mounted wing or wing part comprising an oscillation attenuation system based on mass inertia on the upper wing face (only in one direction), comprising base elements (23)

FIG. 22:

End piece of a folded hose using the example of the base/end piece of a sachet

FIG. 23:

End piece of an unfolded hose using the example of a the base/end piece of a sachet

FIG. 24:

End piece of a folded hose using the example of the base/end piece of a foldable drink container comprising a curved base

FIG. 25:

End piece of an unfolded hose using the example of the base/end piece of a foldable drink container comprising a curved base

For a Multifunctional Actuator

The invention is described in the following by way of examples and drawings, which show the following:

FIG. 1:

An actuator (2) according to the invention in the folded state in the rest position

FIG. 2

An actuator (2) according to the invention in the unfolded state in the end position/working position

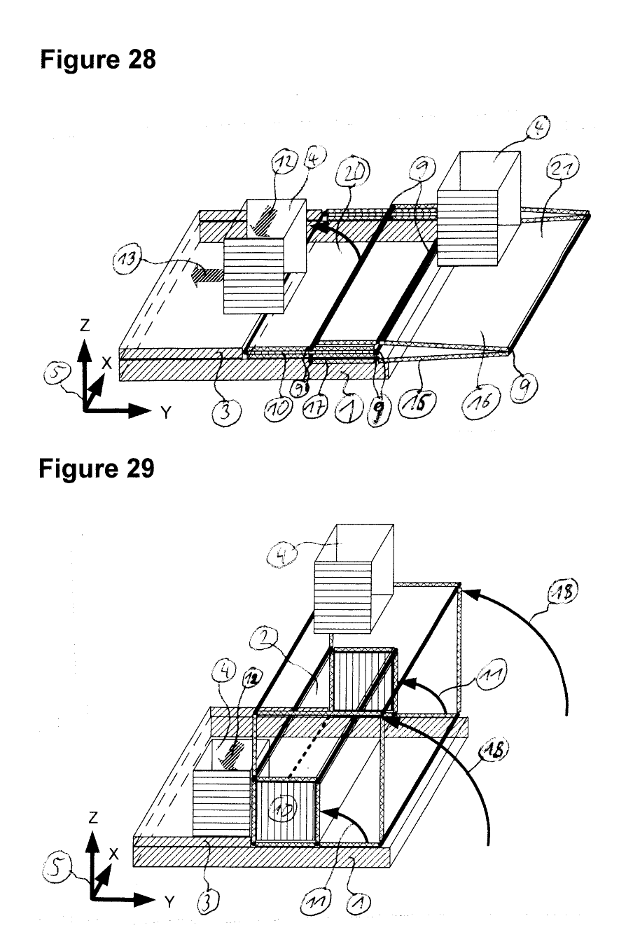

FIG. 28:

An actuator (2) according to the invention comprising an attached lifting/sliding device in the folded state in the rest position

FIG. 29:

An actuator (2) according to the invention comprising an attached lifting/sliding device in the unfolded state in the end position/working position

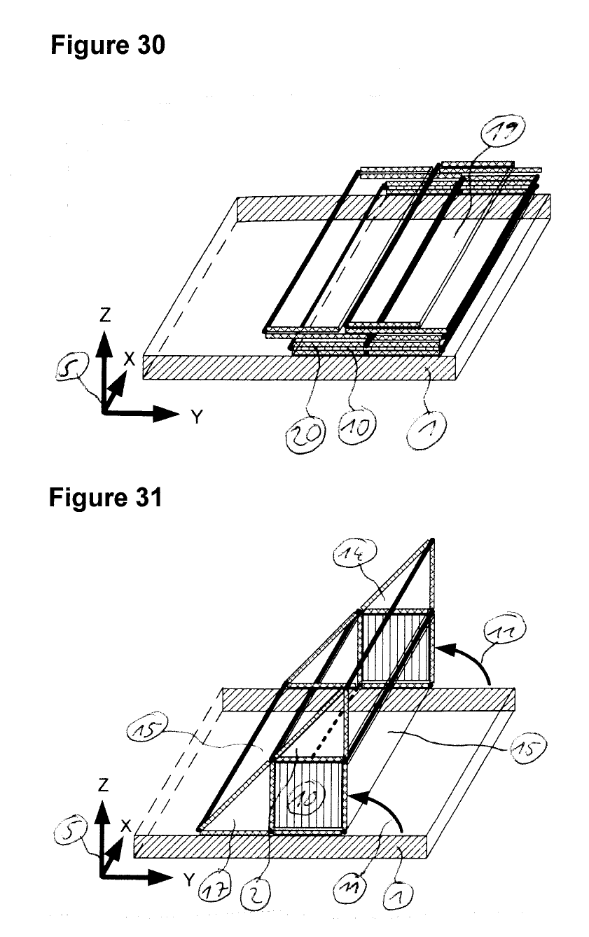

FIG. 30:

An actuator (2) according to the invention comprising an attached barrier device/flood protection device in the folded state in the rest position

FIG. 31:

An actuator (2) according to the invention comprising an attached barrier device/flood protection device in the unfolded state in the end position/working position

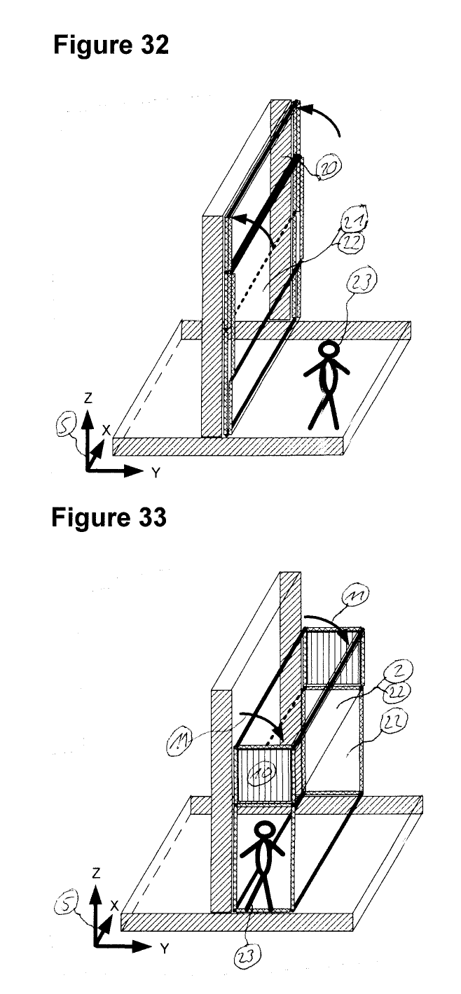

FIG. 32:

An actuator (2) according to the invention comprising an attached safety device/safety rescue tunnel device in the folded state in the rest position

FIG. 33:

An actuator (2) according to the invention comprising an attached safety device/safety rescue tunnel device in the unfolded state in the end position/working position

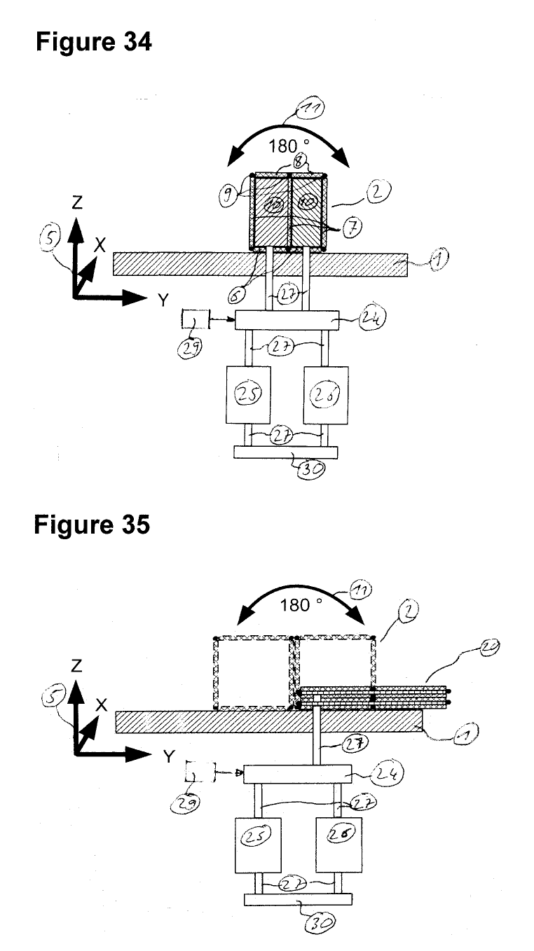

FIG. 34:

A double actuator (2) according to the invention, comprising a divided pressure region and thus two pressure regions for a rotational movement 180 degrees

FIG. 35:

A double actuator (2) according to the invention comprising two pressure regions for a rotational movement 180 degrees

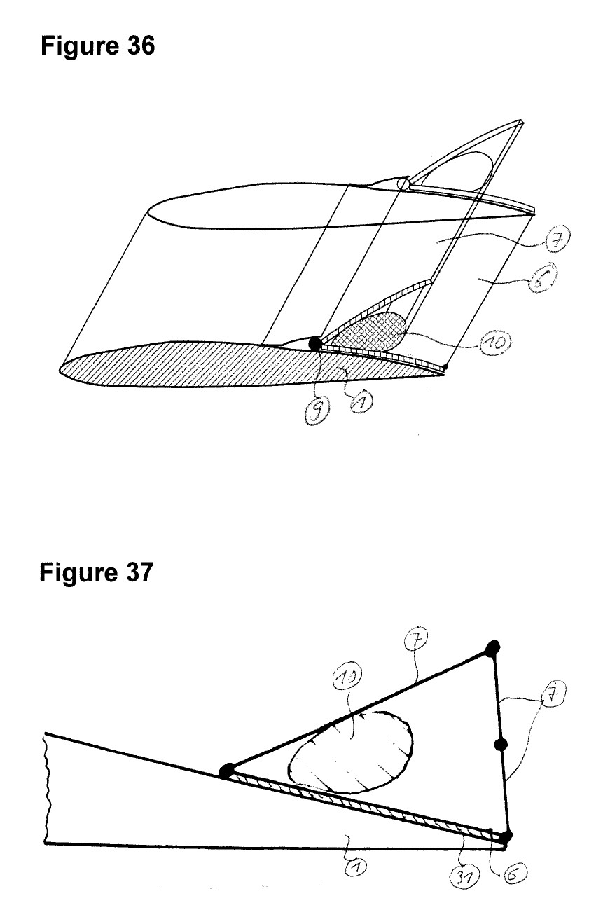

FIG. 36:

A very simple unfolded actuator (2) according to the invention comprising only one face/wall and a joint having a rotational movement 90 degrees

FIG. 37

A very simple unfolded actuator (2) according to the invention comprising two faces/walls and a joint having a rotational movement 90 degrees and an excursion limitation

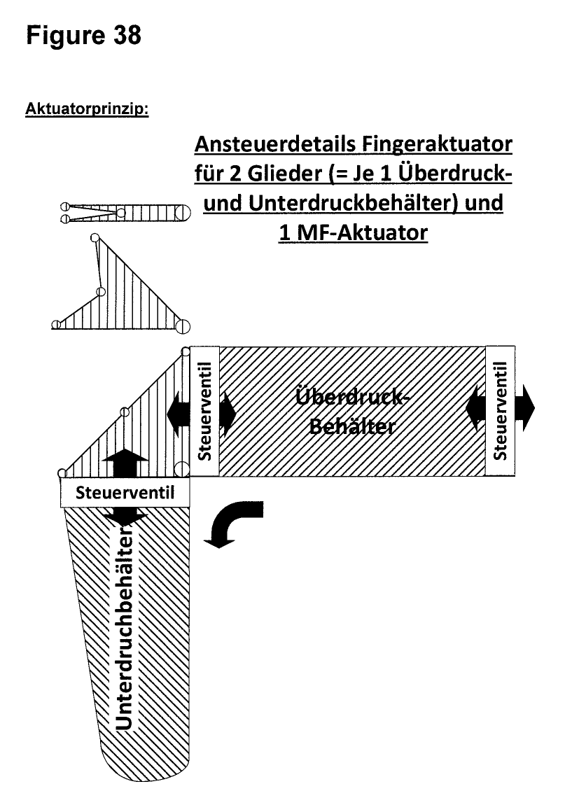

FIG. 38 A parallelogram actuator according to the invention for a finger actuator for 2 finger members along with actuation details

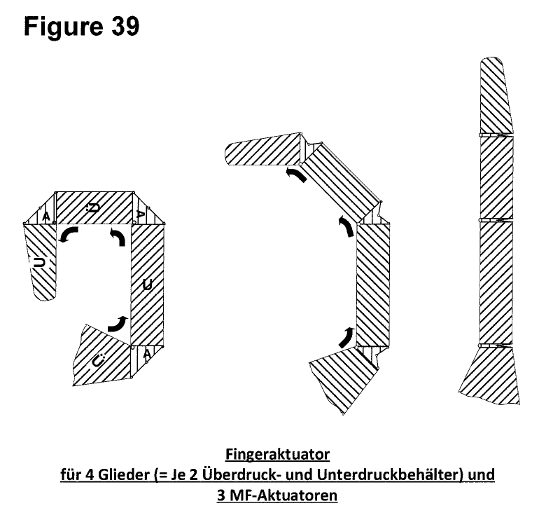

FIG. 39:

A plurality (3) of parallelogram actuators according to the invention for a finger actuator for 4 finger members in a stretched and bent arrangement

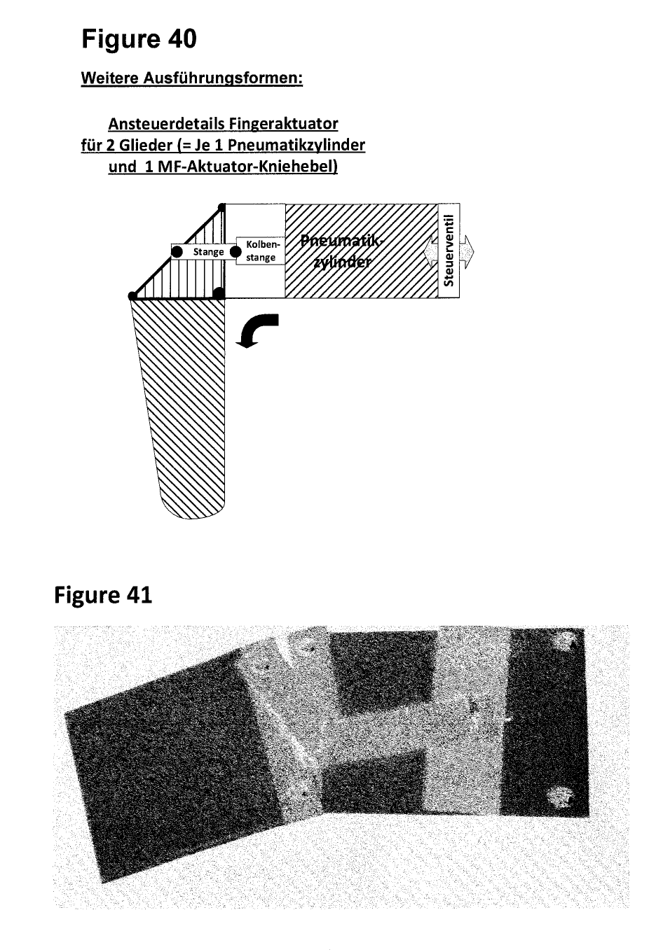

FIG. 40:

A parallelogram according to the invention in combination with a pneumatic cylinder for 2 finger members in a bent arrangement along with actuation details

FIG. 41:

Model of the parallelogram according to the invention in combination with a pneumatic cylinder (comprising a piston rod) for 2 finger members in a bent arrangement along with actuation details

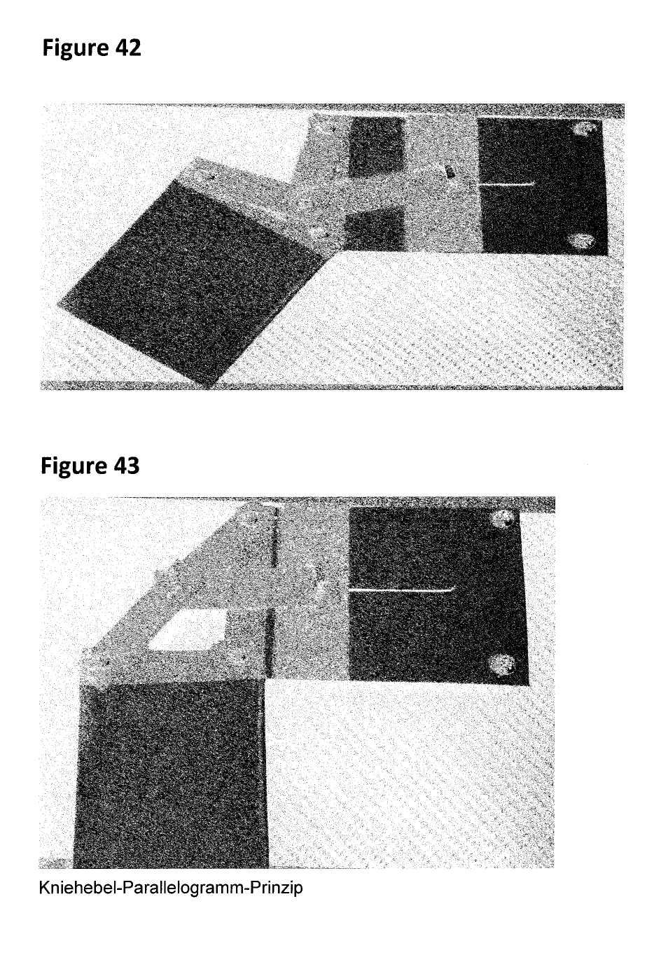

FIG. 42:

Model of the parallelogram according to the invention in combination with a pneumatic cylinder (without a piston rod) for 2 finger members stretched

FIG. 43:

Model of the parallelogram according to the invention in combination with a pneumatic cylinder (without a piston rod) for 2 finger members slightly bent

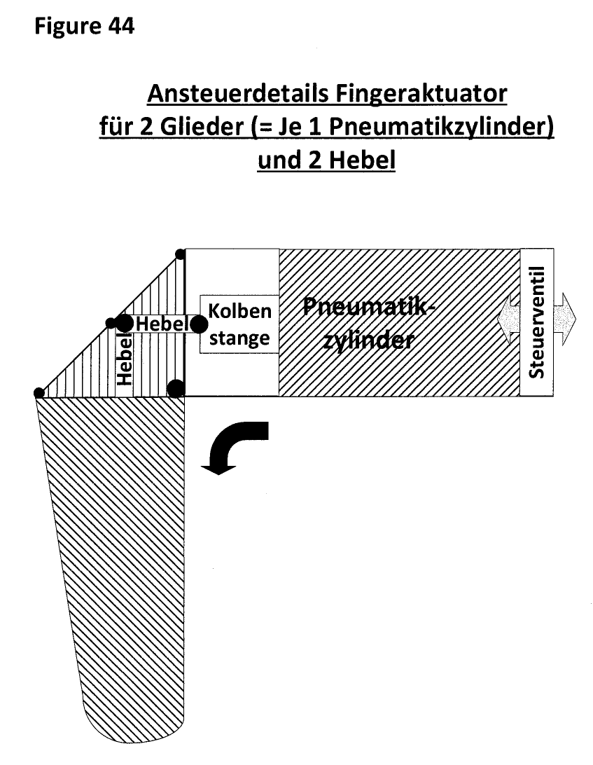

FIG. 44:

Parallelogram according to the invention in combination with a pneumatic cylinder (comprising 2 levers and a piston rod) for 2 finger members bent along with actuation details

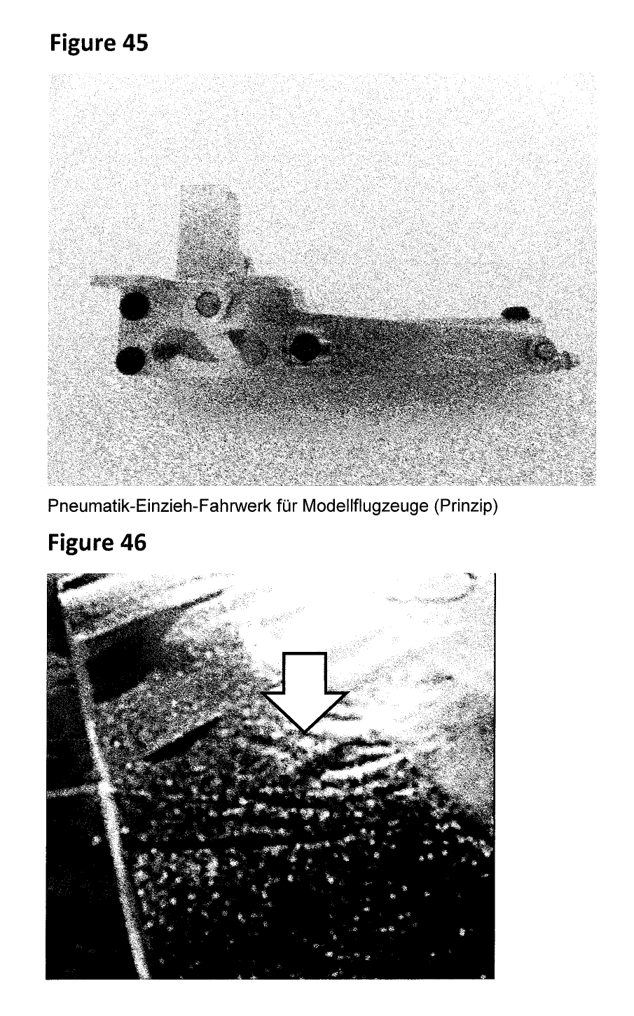

FIG. 45:

Model of a pneumatic retractable undercarriage according to the invention

FIG. 46:

At the arrow, curving up of the back-flow flap at even a low angle of attack

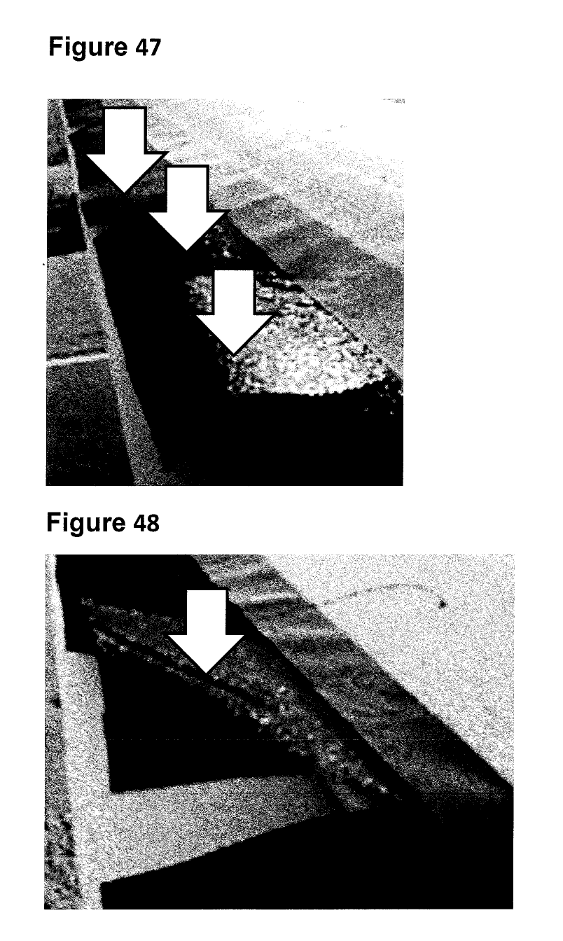

FIG. 47:

At the arrows, curving up of the back-flow flaps at a medium angle of attack

FIG. 48:

Lifting of the back-flow flaps at a high angle of attack (see arrow)

### LIST OF REFERENCE NUMERALS FOR FIGS. 1 TO 25 FOR A BACK-FLOW FLAP

1. Trailing edge separation vortex
2. Flap separation vortex
3. Aerodynamic/hydrodynamic body/wing/profile
4. Prior art back-flow flaps (lift element)
5. Boundary component
6. Trailing profile edge

### 7. Joint

8. Triangular back-flow flap (flap/lift element)
9. Arc-shaped back-flow flap (flap/lift element)
10. Parallelogram back-flow flap (flap/lift element)
11. Resilient material/hinge
12. Springy material

### 13. Hose

14. Fluid/gas filling region
15. Hydraulic/pneumatic cylinder or other actuator
16. Support face/connection point with respect to the wing
17. Angle of attack α of the wing
18. Fluid/gas connection
19. Point of the greatest profile thickness
20. Flap transition
21. Flap region boundary
22. Actuator element
23. Base element
24. Lightning protection system
25. Noise-reducing lift element and/or base element
26. Means for limiting the excursion
27. Fixing means
28. Mass inertia element

### 29. Lever

30. Centre of rotation
31. Torque zero of the profile
32. Lifting force F_{L} (resultant)

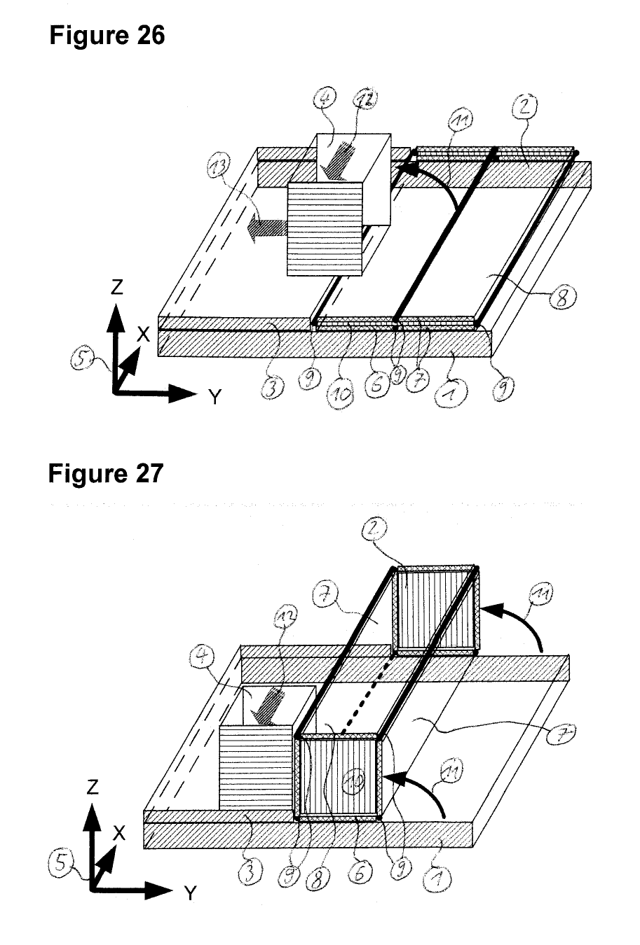

### LIST OF REFERENCE NUMERALS FOR FIGS. 26 TO 45 FOR A MULTIFUNCTIONAL ACTUATOR

1. Base body

### 2. Actuator

3. Support plate

### 4. Workpiece/component

5. Coordinate system
6. Base face/wall
7. Side face/wall
8. Cover face/wall
9. Joint/joint element
10. Fluid-filled space/hose
11. Rising/unfolding movement of the actuator (2) (2-dimensional)
12. Base movement of the component (4)/workpiece
13. Orientation movement of the component (4)/workpiece (1- or 2-dimensional)
14. Device for orientating and/or lifting
15. Side wall of the mounted orientating and/or lifting device
16. Cover wall of the mounted orientating and/or lifting device
17. Base wall of the mounted orientating and/or lifting device
18. Lifting movement and onward movement of the workpiece
19. Device which is orientated
20. Actuator (2) which is folded into rest position
21. Mounted device which is folded into rest position
22. Protection system and/or emergency system and/or ventilation system

### 23. Person

24. Directional valves
25. Overpressure container
26. Underpressure container

### 27. Pipelines

28. Excursion limitation
29. Control and regulation system

### 30. Compressor

31. Fixing element
32. Control valve
33. Pneumatic cylinder

### 34. Piston rod

### 35. Rod

### 36. Lever

37. Pneumatic retractable undercarriage

### Preferred Embodiments

1. Device in the form of a wind turbine rotor blade having a passive and/or active flap system, which can be used to improve the output at least in the regions for improvement A and/or B and/or C and/or D, in the form of a base element which reinforces the rotor blade, characterised in that said system is formed by for example a rotor blade trailing edge reinforcement comprising at least one triangular or Z-shaped or V-shaped or leading-edge-shaped or polygonal base element, and thus statically reinforces (optionally repairs) the rotor blade structure and/or protects it from external influences, in particular at the trailing edge and optionally at the leading edge (wing tip) and optionally at particular portions of the rotor blade/points on blade segments, optionally to attach vortex generators and/or other base elements and/or flaps and/or lightning protection.

2. Device in the form of a wind turbine rotor blade having a passive and/or active flap system, which can be used to improve the output at least in the regions for improvement A and/or B and/or C and/or D, in the form of an at least noise-reducing lift element and/or base element,

characterised in that, by way of a flexible and/or solid shaped, in particular toothed, jagged, bristly, perforated, particularly preferably slitted, thread-shaped, bird-feather-shaped, finger-shaped (kinked rod or tube) and spiral-shaped (2D or 3D spiral) trailing edge of the lift element and/or of the base element (leading and trailing possible), and that as a result generates less noise or less noise than in the original state of the rotor blade (when retrofit).

3. Wind turbine rotor blade having a passive and/or active flap system, which can be used to improve the output at least in the regions for improvement A and/or B and/or C and/or D, and for reducing the loads on the rotor blade and optionally hub structure and as a result dynamic rotor oscillations are excited transverse to the profile chord (flapwise,

dynamic yaw oscillations) and parallel to the profile chord of the rotor blade (edgewise) and can lead to considerable tip loads of the rotor blade, and this being able to lead to material fatigue (or reduced service life) in the long term,
characterised in that at least one oscillation attenuation element is used, this taking place in the form of at least one active and/or passive flap, and in that this rotor blade reacts through mass compensation and/or pneumatically and/or hydraulically and/or magnetorheologically, and has an attenuating effect by way of at least one passive and/or active lift element, and as a result the service life of the rotor blade and/or of the wind turbine and/or of the flap system is potentially increased.

4. Device in the form of a wind turbine rotor blade having a passive and/or active flap system, which can be used to improve the output at least in the regions for improvement C and/or D, and operates in the function of a storm protector/overspeed protector, prevents overloads on the rotor blades, and makes possible an increase in output at speeds resulting from a relatively long high wind running duration at greater than V_{MaxNormal}, as a result of which there is sufficient overload protection for gusts/thermal lift, for example at <50% nominal power, preferably at <70% nominal power, particularly preferably ≤95% nominal power, most preferably ≤100% nominal power,

characterised in that this is achieved by at least one lift-reducing (upper face and optionally lower face) flap/lift element of the rotor blade, and in that there is no cut-off at the speed V_{MaxNormal}, but instead, by way of the active flap system, braking is provided on at least the upper face of the wind turbine, by increasing resistance and/or reducing lift, at least to such an extent that the nominal power is not exceeded and/or there is no overload and/or the network stability is not disrupted, and in that this is activated and/or controlled and/or regulated by actively activated flaps, optionally including by rotor blade measurement and/or centrifugal force measurement and/or mass inertia/acceleration measurement and/or speed measurement.

5. Device in the form of a wind turbine rotor blade having a passive and/or active flap system, which can be used to improve the output at least in the regions for improvement A and/or B in the function of a startup aid in low wind and yield output improvement, by way of at least one lift-increasing lift element which greatly increases the lift coefficient and thus the energy output at high angles of attack (up to approximately V_{Nominal}),

characterised in that this lift element is preferably attached to the upper face, particularly preferably to the trailing edge of the upper face of the rotor blade, and is activated and/or controlled and/or regulated pneumatically and/or hydraulically and/or magnetorheologically by passively and/or actively activated flaps, and in that, for example before V_{Nominal}, the pitch control/regulation and/or the lift-controlling flap regulation can be used so as to regulate the turbine to the maximum power, or in that, for example before V_{Nominal}, the pitch control/regulation (fine regulation) and the lift-controlling flap regulation (rough regulation) can be used to regulate the turbine to the maximum power, or in that, for example before V_{Nominal}, the pitch control/regulation (rough regulation) and the lift-controlling flap regulation (fine regulation) can be used to regulate the turbine to the maximum power.

6. Device in the form of a wind turbine rotor blade having an active and/or passive flap system, which can be used to improve the output at least in the regions for improvement A and/or B and/or C and/or D, and/or in the function of a system for increasing the rigidity and/or limiting the excursion of the flap, and/or a rotor-blade-reinforcing base element and/or lightning protection, and/or a startup aid in low wind, and/or an ice and snow removal system,

characterised in that means for increasing the rigidity of the flap and/or means for limiting the excursion are used, and in that at least part of the flap has a high rigidity and preferably exceeds a rigidity in the form of a tensile modulus of elasticity of at least 50 GPa and/or a tensile strength of at least 0.4 GPa.

7. Device in the form of a wind turbine rotor blade having a passive and/or active flap system, which, to improve the output at least in the regions of improvement A and/or B and/or C and/or D, can be used in the function of a system for increasing the rigidity and/or limiting the excursion of the flap, and/or a system having a long service life and high capacity for retrofitting, and/or a base element which reinforces a rotor blade, and/or a lightning protector, and/or a noise-reducing lift element and/or base element, and/or an oscillation attenuation system comprising at least one oscillation attenuation element, and/or a storm protector/overspeed protector, and/or a startup aid in low wind, and/or an overspeed protector and/or oscillation attenuation system using at least one lift-reducing lift element and if applicable comprising sealable pressure compensation openings and/or an ice and snow removal system,

characterised in that means for increasing the rigidity of the flap and/or means for limiting the excursion are used, and in that the excursion limitation limits the opening angle of the flap of <90 degrees, preferably <75 degrees, particularly preferably <60 degrees.

8. Device in the form of a wind turbine rotor blade comprising the following:

adjustable flaps or lift elements, which are arranged on the surface of the wind turbine rotor blade and arranged in the longitudinal direction of the rotor blade and make it possible to adjust activating means, and thus to change the aerodynamic properties and/or noise reduction properties of the lift element and/or base element, and/or oscillation attenuation properties using at least one oscillation attenuation element, and/or storm protection properties/overspeed protection, and/or as a startup aid in low wind, and/or as an overspeed protector and/or oscillation attenuation properties by means of at least one lift-reducing lift element and optionally comprising sealable pressure compensation openings, and/or ice and snow removing properties of the rotor blade, the flaps or lift elements and the activating means being formed and arranged with the aim that activating the activating means reduces the lift in a zone, and/or can increase the lift in this zone and greatly increase the output at medium to high angles of attack of the rotor blade and at least in a position of the angle of attack which extends from a first point close to the rotor blade tip to a second point between the first point and the blade root, this second point being variable in the longitudinal direction of the rotor blade by adjusting the activating means,
characterised in that the lift regulation means are formed from at least one flexible flap and/or rigid flap and/or a plurality of small rigid and/or flexible flaps, the at least one flap and/or at least a plurality of small flaps being arranged in the longitudinal direction of the blade and being adjustable by means of one or more activating means, in such a way that the position of the flap or plurality of small flaps, which changes the lift, can be rapidly and/or gradually changed in the longitudinal direction of the flap or plurality of small flaps, and that the activating means can be used as a fluid-fillable (inflatable) and/or foldable element, preferably part of the lift element or the lift element itself.

9. Device in the form of a wind turbine rotor blade comprising the following:

adjustable flaps or lift elements, which are arranged on the surface of the wind turbine rotor blade and arranged in the longitudinal direction of the rotor blade and make it possible to adjust activating means, and thus to change the aerodynamic properties and/or noise reduction properties of the lift element and/or base element, and/or oscillation attenuation properties using at least one oscillation attenuation element, and/or storm protection properties/overspeed protection, and/or as a startup aid in low wind, and/or as an overspeed protector and/or oscillation attenuation properties by means of at least one lift-reducing lift element and optionally comprising sealable pressure compensation openings, and/or ice and snow removing properties of the rotor blade, the flaps or lift elements and the activating means being formed and arranged with the aim that activating the activating means reduces the lift in a zone, and/or can increase the lift in this zone and greatly increase the output at medium to high angles of attack of the rotor blade and at least in a position of the angle of attack which extends from a first point close to the rotor blade tip to a second point between the first point and the blade root, this second point being variable in the longitudinal direction of the rotor blade by adjusting the activating means,
characterised in that the lift regulation means are formed from at least one flexible flap and/or rigid flap and/or a plurality of small rigid and/or flexible flaps,
and in that these flaps have increased rigidity of the flaps and/or means for limiting the excursion, in particular foldable,
the at least one flap and/or at least a plurality of small flaps being arranged in the longitudinal direction of the blade and being adjustable by means of one or more activating means, in such a way that the position of the flap or plurality of small flaps, which changes the lift, can be changed rapidly and/or gradually in the longitudinal direction of the flap or plurality of small flaps.

10. Device in the form of a wind turbine rotor blade comprising the following:

adjustable flaps or lift elements, which are arranged on the surface of the wind turbine rotor blade and arranged in the longitudinal direction of the rotor blade and make it possible to adjust activating means, which are not a hose integrated into the wing, and thus to change the aerodynamic properties and/or noise reduction properties of the lift element and/or base element, and/or oscillation attenuation properties using at least one oscillation attenuation element, and/or storm protection properties/overspeed protection, and/or as a startup aid in low wind, and/or as an overspeed protector and/or oscillation attenuation properties by means of at least one lift-reducing lift element and optionally comprising sealable pressure compensation openings, and/or ice and snow removing properties
of the rotor blade, the flaps or lift elements and the activating means being formed and arranged with the aim that activating the activating means reduces the lift in a zone, and/or can increase the lift in this zone and greatly increase the output at medium to high angles of attack of the rotor blade and at least in a position of the angle of attack which extends from a first point close to the rotor blade tip to a second point between the first point and the blade root, this second point being variable in the longitudinal direction of the rotor blade by adjusting the activating means,
characterised in that the lift regulation means are formed from at least one flexible flap and/or rigid flap and/or a plurality of small rigid and/or flexible flaps, and in that the activating means consist of at least one fluid-fillable hose, which in particular is foldable and deforms preferably only 2-dimensionally during filling, and in that the activating means system consists of at least one fluid-fillable hose, a line system, at least one pressure store and at least one control valve, the at least one flap or at least a plurality of small flaps being arranged in the longitudinal direction of the blade and being adjustable by means of one or more activating means, in such a way that the position of the flap or plurality of small flaps, which changes the lift, can be changed rapidly and/or gradually in the longitudinal direction of the flap or plurality of small flaps.

11. Device in the form of a wind turbine rotor blade having a passive and/or active flap system, which can be used to improve the output at least in the regions for improvement A and/or B and/or C and/or D, which is retrofittable and/or can be removed again in a simple manner and has a high service life,

characterised in that the rotor blade structure is statically not impaired or not significantly impaired by the attachment by adhesive connection (large adhesive area), for example to the base element (23), rivet connection, screw connection, scissor (or pincer) connection, suspension connection, clamp connection or plug-in connection, and thus makes possible a high service life of the rotor blade and/or wind turbine and/or flap system, preferably >5 years, particularly preferably >10 years, most preferably ≥20 years, and/or optionally makes simple removal/replacement possible. For depreciation of a for example retrofittable system, the service life thereof is of major importance. Depreciation times of ≤4 years are conventional.

12. Device in the form of a wind turbine rotor blade having a passive and/or active flap system (8, 9, 10), which can be used to improve the output at least in the regions for improvement A and/or B and/or C and/or D, in the form of a fluid-fillable (inflatable) actuator element (22), and if necessary can in a very simple manner be retrofitted and/or attached and/or replaced on a flap,

characterised in that at least one actuator element (22) and/or a part thereof is fillable with a fluid (inflatable), and can simultaneously be folded at least in the initial state.

13. Device according to any of the preceding embodiments, characterised in that the flap itself or a hose (13) is pneumatically and/or hydraulically and/or magnetorheologically fillable (inflatable), and in this context is deformed 2-dimensionally (without significant stretching of the hose material), potentially 3-dimensionally (with significant stretching of the hose material), and the flap/lift element (4, 8, 9, 10) is thus moved by the actuator element (22), and in that the flap and/or actuator element consists of a triangular, parallelogram, hose-shaped or polygonal, check-valve-form lift element (4, 8, 9, 10), and in that the flap and/or actuator element is reinforced by a macrostatic system, by for example triangular, parallelogram, hose-shaped or polygonal, planar-check-valve-form, curve-shaped structures and the like.

14. Device according to any of the preceding embodiments having a static and/or aerodynamic effect,

characterised in that the flap (4, 8, 9, 10) and/or actuator element (22) is reinforced by a microstatic system by way of for example lasered, pressed, embossed, punched, printed, etched, printed surfaces structures, for example similar to bird feathers, and textile reinforcement fibres such as GFRP, CFRP, Kevlar, basalt (optionally integrated) and the like. Surface structures of this type may also comprise small or larger ducts which positively influence the hysteresis of raising the back-flow flap (4, 8, 9, 10).

15. Device according to any of the preceding embodiments having a static and/or aerodynamic effect,

characterised in that the flap (4, 8, 9, 10) and/or actuator element (22) is reinforced by a microstatic system by way of for example lasered, pressed, embossed, punched, printed, etched, printed surfaces structures, for example similar to bird feathers, and textile reinforcement fibres such as GFRP, CFRP, Kevlar, basalt (optionally integrated) and the like. Surface structures of this type may also comprise small or larger ducts which positively influence the hysteresis of raising the back-flow flap (4, 8, 9, 10).

16. Device according to any of the preceding embodiments having a static and/or aerodynamic effect,

characterised in that the flap (4, 8, 9, 10) has at least one stop means, such as a Kevlar string, wire, strips, lever, the lift element itself, lamella, hose, grid, bellows (preferably lateral), which limits the maximum deflection.

It is necessary to limit the excursion in aeroplanes for safety reasons in dangerous flight states and for the service life. In wind turbines, it is necessary to limit the excursion in snow/ice for safety reasons and for the service life. Slightly earlier startup of the rotor should also be expected in the case of active activation.

17. Device according to any of the preceding embodiments having a static and/or aerodynamic effect,

characterised in that the flap and/or actuator element consists of at least one lift element which consists of at least a curved or multiply curved plate (3D plate) such as a blind lamella or the like. This is advantageous for adaptation to the profile curvature.

18. Device according to any of the preceding embodiments, characterised in that the actuator element (22) can be filled and/or emptied very rapidly if required by means of an overpressure and/or underpressure store system.

This is advantageous in particular for rapid and simple fluid provision, and makes possible a double-action hydraulic and/or pneumatic actuator which reacts rapidly. Preferably, this overpressure and/or underpressure storage system is attached/accommodated in the rotor nose/spinner/rotor blade root.

19. Device in the form of a wind turbine rotor blade having a passive and/or active flap system, which can be used to improve the output at least in the regions for improvement A and/or B and/or C and/or D, in the form of a base element (23) which reinforces the rotor blade,

characterised in that said system is formed by for example a rotor blade trailing edge reinforcement comprising at least one triangular or Z-shaped or V-shaped or leading-edge-shaped or polygonal base element (23), and thus statically reinforces (optionally repairs) the rotor blade structure and/or protects it from external influences, in particular at the trailing edge and optionally at the leading edge (wing tip) and optionally at particular portions of the rotor blade/points on blade segments, optionally to attach vortex generators and/or other base elements and/or flaps and/or lightning protection.

In the case of V-shaped trailing edge base elements (23), it is possible to provide for example a small duct which is of approximately the thickness of the trailing edge itself and which can provide the pneumatic, hydraulic, electrical supply and/or the lightning protector discharge.

The base element or parts thereof may also be used as a lightning protector.

20. Device in the form of a wind turbine rotor blade having a passive and/or active flap system, which can be used to improve the output at least in the regions for improvement A and/or B and/or C and/or D, in the form of an at least noise-reducing lift element and/or base element,

characterised in that, by way of a flexible and/or solid shaped, in particular corrugated, toothed, jagged, bristly, perforated, particularly preferably slitted, thread-shaped, bird-feather-shaped, finger-shaped (kinked rod or tube) and spiral-shaped (2D or 3D spiral) trailing edge of the lift element and/or of the base element (leading and trailing possible), and that as a result generates less noise or less noise than in the original state of the rotor blade (when retrofit).

Elements of this type formed in this manner can also be attached to complete parts of wings, in particular outboard wings and/or rudders.

21. Wind turbine rotor blade having a passive and/or active flap system, which can be used to improve the output at least in the regions for improvement A and/or B and/or C and/or D, and for reducing the loads on the rotor blade and optionally hub structure and as a result dynamic rotor oscillations are excited transverse to the profile chord and (dynamic yaw oscillations) parallel to the profile chord of the rotor blade and can lead to considerable tip loads of the rotor blade, and this being able to lead to material fatigue (or reduced service life) in the long term,

characterised in that at least one oscillation attenuation element is used, this taking place in the form of at least one active and/or passive flap, and in that this rotor blade reacts through mass compensation and/or pneumatically and/or hydraulically and/or magnetorheologically, and has an attenuating effect by way of at least one passive and/or active lift element, and as a result the service life of the rotor blade and/or of the wind turbine and/or of the flap system is potentially increased.

22. Device in the form of a wind turbine rotor blade having a passive and/or active flap system, which can be used to improve the output at least in the regions for improvement C and/or D, and operates in the function of a storm protector/overspeed protector, prevents overloads on the rotor blades, and makes possible an increase in output at speeds resulting from a relatively long high wind running duration at greater than V_{MaxNormal}, as a result of which there is sufficient overload protection for gusts/thermal lift, for example at <50% nominal power, preferably at <70% nominal power, particularly preferably ≤95% nominal power, most preferably ≤100% nominal power,

characterised in that this is achieved by at least one lift-reducing (upper face and optionally lower face) flap/lift element of the rotor blade, and in that there is no cut-off at the speed V_{MaxNormal}, but instead, by way of the active flap system, braking is provided on at least the upper face of the wind turbine, by increasing resistance and/or reducing lift, at least to such an extent that the nominal power is not exceeded and/or there is no overload and/or the network stability is not disrupted, and in that this is activated and/or controlled and/or regulated by actively activated flaps, optionally including by rotor blade measurement and/or centrifugal force measurement and/or mass inertia/acceleration measurement and/or speed measurement.

The flap may also be passively activated by mass inertia forces/mass inertia torques, as is shown and disclosed in FIG. 19-21.

23. Device and method in the form of a wind turbine rotor blade having a passive and/or active flap system, which can be used to improve the output at least in the regions for improvement A and/or B in the function of a startup aid in low wind and yield output improvement, by way of at least one lift-increasing lift element which greatly increases the lift coefficient and thus the energy output at high angles of attack (up to approximately V_{Nominal}), characterised in that this lift element is preferably attached to the upper face, particularly preferably to the trailing edge of the upper face of the rotor blade, and is activated and/or controlled and/or regulated pneumatically and/or hydraulically and/or magnetorheologically by passively and/or actively activated flaps, and in that, for example before V_{Nominal}, the pitch control/regulation and/or the lift-controlling flap regulation can be used so as to regulate the turbine to the maximum power, or in that, for example before V_{Nominal}, the pitch control/regulation (fine regulation) and the lift-controlling flap regulation (rough regulation) can be used to regulate the turbine to the maximum power or that, for example before V_{Nominal}, the pitch control/regulation (rough regulation) and the lift-controlling flap regulation (fine regulation) can be used to regulate the turbine to the maximum power.

24. Device in the form of a wind turbine rotor blade having a passive and/or active flap system, which can be used to improve the output at least in the regions for improvement C and/or D in the function of an overspeed and/or oscillation attenuation and lift-reducing lift element,

characterised in that, by way of the flap and/or lift element and/or actuator (22) and/or a hose (13), openable and sealable openings (18) between the upper face carrying overpressure and the lower face carrying underpressure can be used for lift reduction, at least in part by pressure compensation, that the flap and/or actuator element (22) and/or a hose (13) and the openable and closable openings (18) and/or valves are attached preferably in the region of greatest thickness of the profile (19), particularly preferably to the trailing edge of the profile/rotor blade.

Preferably, the active actuator element (22) seals the openable and sealable openings (18) and/or valves.

25. Device and method in the form of a wind turbine rotor blade having an active and/or passive flap system, which can be used to improve the output at least in the regions for improvement A and/or B and/or C and/or D, in the function of an ice and snow removal system,

characterised in that by way of the forces and/or movement of the active flap the snow and/or ice accumulation of the rotor blade can be removed at least in part, potentially proactively in advance, and thus potentially prevented at least in part, and in that, by way of actively activated (lifted) flaps, which are pneumatically and/or hydraulically and/or magnetorheologically activated and/or controlled and/or regulated, the snow and/or ice accumulation is removed at least in part, potentially proactively in advance, and thus potentially prevented at least in part, and/or in that the at least intermittently heated base elements (23) and/or lift elements and/or flaps are provided with an antiadhesive film or coating so as to reduce environmental influences such as accumulation of midges and damage from bird strikes.

It is known that specifically the wing tip experiences a rougher surface (worsened aerodynamics and service life) over time as a result of weathering, and that for this purpose a glued-on antiadhesive film of for example PTFE also prevents the accumulation of midges, which are particularly numerous in spring, at least in part, and protects the rotor blade from weathering and bird strikes and saltwater atmospheres (in coastal or offshore wind turbines). This weathering protection may also act as a base element (23) in that it has reinforcements, to which components are fixed, in particular regions.

26. Device in the form of a wind turbine rotor blade having an active and/or passive flap system, which can be used to improve the output at least in the regions for improvement A and/or B and/or C and/or D, and/or in the function of a system for increasing the rigidity and/or limiting the excursion of the flap, and/or a rotor-blade-reinforcing base element and/or lightning protection, and/or a startup aid in low wind, and/or an ice and snow removal system,

characterised in that means for increasing the rigidity of the flap and/or means for limiting the excursion are used, and in that at least part of the flap has a high rigidity and preferably exceeds a rigidity in the form of a tensile modulus of elasticity of at least 50 GPa and/or a tensile strength of at least 0.4 GPa.

27. Device in the form of a wind turbine rotor blade having a passive and/or active flap system, which, to improve the output at least in the regions of improvement A and/or B and/or C and/or D, can be used in the function of a system for increasing the rigidity and/or limiting the excursion of the flap, and/or a system having a long service life and high capacity for retrofitting, and/or a base element which reinforces a rotor blade, and/or a lightning protector, and/or a noise-reducing lift element and/or base element, and/or an oscillation attenuation system comprising at least one oscillation attenuation element, and/or a storm protector/overspeed protector, and/or a startup aid in low wind, and/or an overspeed protector and/or oscillation attenuation system using at least one lift-reducing lift element and if applicable comprising sealable pressure compensation openings and/or an ice and snow removal system,

characterised in that means for increasing the rigidity of the flap and/or means for limiting the excursion are used, and in that the excursion limitation limits the opening angle of the flap of <90 degrees, preferably <75 degrees, particularly preferably <60 degrees/The opening angle of the flap is defined in such a way that the leading and trailing edge of the flap determine the opening angle, this thus also being possible in highly flexible or partially flexible flaps.

28. Device in the form of a wind turbine rotor blade having a passive and/or active flap system, which, to improve the output at least in the regions of improvement A and/or B and/or C and/or D, can be used in the function of a system for increasing the rigidity and/or limiting the excursion of the flap, and/or a system having a long service life and high capacity for retrofitting, and/or a base element which reinforces a rotor blade, and/or a lightning protector, and/or a noise-reducing lift element and/or base element, and/or an oscillation attenuation system comprising at least one oscillation attenuation element, and/or a storm protector/overspeed protector, and/or a startup aid in low wind, and/or an overspeed protector and/or oscillation attenuation system using at least one lift-reducing lift element and if applicable comprising sealable pressure compensation openings and/or an ice and snow removal system,

characterised in that a fluid-fillable (inflatable) and/or foldable element, preferably part of the actuator element or the lift element itself, can be used.

29. Device in the form of a wind turbine rotor blade having a passive and/or active flap system, which, to improve the output at least in the regions of improvement A and/or B and/or C and/or D, can be used in the function of a system for increasing the rigidity and/or limiting the excursion of the flap, and/or a system having a long service life and high capacity for retrofitting, and/or a base element which reinforces a rotor blade, and/or a lightning protector, and/or a noise-reducing lift element and/or base element, and/or an oscillation attenuation system comprising at least one oscillation attenuation element, and/or a storm protector/overspeed protector, and/or a startup aid in low wind, and/or an overspeed protector and/or oscillation attenuation system using at least one lift-reducing lift element and if applicable comprising sealable pressure compensation openings and/or an ice and snow removal system,

characterised in that a fluid-fillable (inflatable) and/or foldable element, preferably part of the actuator element or the lift element itself, can be used.

30. Device in the form of a wind turbine rotor blade comprising the following:

adjustable flaps or lift elements, which are arranged on the surface of the wind turbine rotor blade and arranged in the longitudinal direction of the rotor blade and make it possible to adjust activating means, and thus to change the aerodynamic properties of the rotor blade, the flaps or lift elements and the activating means being formed and arranged with the aim that activating the activating means reduces the lift in a zone,
and/or can increase the lift in this zone and greatly increase the output at least at high angles of attack of the rotor blade and at least in a position of the angle of attack which extends from a first point close to the rotor blade tip to a second point between the first point and the blade root, this second point being variable in the longitudinal direction of the rotor blade by adjusting the activating means,
characterised in that the lift regulation means are formed from at least one flexible flap and/or rigid flap and/or a plurality of small rigid and/or flexible flaps,
the at least one flap and/or at least a plurality of small flaps being arranged in the longitudinal direction of the blade and being adjustable by means of one or more activating means, in such a way that the position of the flap or plurality of small flaps, which changes the lift,
can be changed rapidly and/or gradually in the longitudinal direction of the flap or plurality of small flaps.

31. Device in the form of a wind turbine rotor blade comprising the following:

adjustable flaps or lift elements, which are arranged on the surface of the wind turbine rotor blade and arranged in the longitudinal direction of the rotor blade and make it possible to adjust activating means and thus to change the aerodynamic properties and/or noise reduction properties of the lift element and/or base element, and/or oscillation attenuation properties using at least one oscillation attenuation element, and/or storm protection properties/overspeed protection, and/or as a startup aid in low wind, and/or as an overspeed protector and/or oscillation attenuation properties by means of at least one lift-reducing lift element and optionally comprising sealable pressure compensation openings, and/or ice and snow removing properties
of the rotor blade, the flaps or lift elements and the activating means being formed and arranged with the aim that activating the activating means reduces the lift in a zone, and/or can increase the lift in this zone and greatly increase the output at least at high angles of attack of the rotor blade and at least in a position of the angle of attack
which extends from a first point close to the rotor blade tip to a second point between the first point and the blade root, this second point being variable in the longitudinal direction of the rotor blade by adjusting the activating means, characterised in that the lift regulation means are formed from at least one flexible flap and/or rigid flap and/or a plurality of small rigid and/or flexible flaps,
the at least one flap and/or at least a plurality of small flaps being arranged in the longitudinal direction of the blade and being adjustable by means of one or more activating means, in such a way that the position of the flap or plurality of small flaps, which changes the lift,
can be changed rapidly and/or gradually in the longitudinal direction of the flap or plurality of small flaps.

32. Device in the form of a wind turbine rotor blade comprising the following:

adjustable flaps or lift elements, which are arranged on the surface of the wind turbine rotor blade and arranged in the longitudinal direction of the rotor blade and make it possible to adjust activating means and thus to change the aerodynamic properties and/or noise reduction properties of the lift element and/or base element, and/or oscillation attenuation properties using at least one oscillation attenuation element, and/or storm protection properties/overspeed protection, and/or as a startup aid in low wind, and/or as an overspeed protector and/or oscillation attenuation properties by means of at least one lift-reducing lift element and optionally comprising sealable pressure compensation openings, and/or ice and snow removing properties
of the rotor blade, the flaps or lift elements and the activating means being formed and arranged with the aim that activating the activating means reduces the lift in a zone, and/or can increase the lift in this zone and greatly increase the output at least at high angles of attack of the rotor blade and at least in a position of the angle of attack
which extends from a first point close to the rotor blade tip to a second point between the first point and the blade root, this second point being variable in the longitudinal direction of the rotor blade by adjusting the activating means,
characterised in that the lift regulation means are formed from at least one flexible flap and/or rigid flap and/or a plurality of small rigid and/or flexible flaps, the at least one flap and/or at least a plurality of small flaps being arranged in the longitudinal direction of the blade and being adjustable by means of one or more activating means, in such a way that the position of the flap or plurality of small flaps, which changes the lift, can be rapidly and/or gradually changed in the longitudinal direction of the flap or plurality of small flaps, and that the activating means can be used as a fluid-fillable (inflatable) and/or foldable element, preferably part of the lift element or the lift element itself.

33. Device in the form of a wind turbine rotor blade comprising the following:

adjustable flaps or lift elements, which are arranged on the surface of the wind turbine rotor blade and arranged in the longitudinal direction of the rotor blade and make it possible to adjust activating means and thus to change the aerodynamic properties and/or noise reduction properties of the lift element and/or base element, and/or oscillation attenuation properties using at least one oscillation attenuation element, and/or storm protection properties/overspeed protection, and/or as a startup aid in low wind, and/or as an overspeed protector and/or oscillation attenuation properties by means of at least one lift-reducing lift element and optionally comprising sealable pressure compensation openings, and/or ice and snow removing properties
of the rotor blade, the flaps or lift elements and the activating means being formed and arranged with the aim that activating the activating means reduces the lift in a zone, and/or can increase the lift in this zone and greatly increase the output at least at high angles of attack of the rotor blade and at least in a position of the angle of attack which extends from a first point close to the rotor blade tip to a second point between the first point and the blade root, this second point being variable in the longitudinal direction of the rotor blade by adjusting the activating means,
characterised in that the lift regulation means are formed from at least one flexible flap and/or rigid flap and/or a plurality of small rigid and/or flexible flaps,
and in that these flaps have an increased rigidity of the flap and/or means for limiting the excursion, in particular foldable,
the at least one flap and/or at least a plurality of small flaps being arranged in the longitudinal direction of the blade and being adjustable by means of one or more activating means, in such a way that the position of the flap or plurality of small flaps, which changes the lift,
can be changed rapidly and/or gradually in the longitudinal direction of the flap or plurality of small flaps.

Angles of attack considered high are those which generate at least approximately the maximum lift coefficient C_{L}, preferably at least 70% of the maximum lift coefficient C_{L}, particularly preferably at least 80% of the maximum lift coefficient C_{L}.

34. Device in the form of a wind turbine rotor blade comprising the following:

adjustable flaps or lift elements, which are arranged on the surface of the wind turbine rotor blade and arranged in the longitudinal direction of the rotor blade and make it possible to adjust activating means, which are not a hose integrated into the wing, and thus to change the aerodynamic properties and/or noise reduction properties of the lift element and/or base element, and/or oscillation attenuation properties using at least one oscillation attenuation element, and/or storm protection properties/overspeed protection, and/or as a startup aid in low wind, and/or as an overspeed protector and/or oscillation attenuation properties by means of at least one lift-reducing lift element and optionally comprising sealable pressure compensation openings, and/or ice and snow removing properties
of the rotor blade, the flaps or lift elements and the activating means being formed and arranged with the aim that activating the activating means reduces the lift in a zone, and/or can increase the lift in this zone and greatly increase the output at least at high angles of attack of the rotor blade and at least in a position of the angle of attack which extends from a first point close to the rotor blade tip to a second point between the first point and the blade root, this second point being variable in the longitudinal direction of the rotor blade by adjusting the activating means,
characterised in that the lift regulation means are formed from at least one flexible flap and/or rigid flap and/or a plurality of small rigid and/or flexible flaps, and in that the activating means consist of at least one fluid-fillable hose, which in particular is foldable and deforms preferably only 2-dimensionally during filling,
and in that the activating means system consists of at least one fluid-fillable hose, a line system, at least one pressure store or underpressure store and at least one control valve, the at least one flap or at least a plurality of small flaps being arranged in the longitudinal direction of the blade and being adjustable by means of one or more activating means, in such a way that the position of the flap or plurality of small flaps, which changes the lift, can be changed rapidly and/or gradually in the longitudinal direction of the flap or plurality of small flaps.

35. Device of a safety system and/or resource energy efficiency improvement system for influencing the flow of an aerodynamic or hydrodynamic body (3), preferably a wing (3), following the principle of a back-flow flap (4), characterised in that said device together with the aerodynamic or hydrodynamic body (3), in particular wing (3), forms at least a partial shift of the flap region boundary (21) by way of the back-flow flap (4) and the boundary component (5) thereof when the back-flow flap (4) is partially and/or completely raised, and the trailing edge separation vortex/vortices (1) and/or flap separation vortex/vortices (2) is/are thus influenced thereby, and in that the flap region boundary (21) is shifted completely to or beyond the profile trailing edge (6) or else only to a part before the profile trailing edge (6), and in that the lift coefficient C_{L} is thus further increased.

36. Device of a safety system and/or resource energy efficiency improvement system for influencing the flow of an aerodynamic or hydrodynamic body (3), preferably a wing (3), following the principle of a back-flow flap (4), characterised in that said device together with the aerodynamic or hydrodynamic body (3), in particular wing (3), forms at least a partial shift of the flap region boundary (21) by way of the back-flow flap (4) and the boundary component (5) thereof when the back-flow flap (4) is partially and/or completely raised, and the trailing edge separation vortex/vortices (1) and/or flap separation vortex/vortices (2) is/are thus influenced thereby, and in that the flap region boundary (21) is shifted completely to or beyond the profile trailing edge (6) or else only to a part before the profile trailing edge (6), and in that the lift coefficient C_{L} is thus further increased and/or the number of pressure regions on the profile is thus further increased from 2 to 3 regions.

37. Device of a safety system and/or resource energy efficiency improvement system for influencing the flow of an aerodynamic or hydrodynamic body (3), preferably a wing (3), following the principle of a back-flow flap (4), characterised in that said device together with the aerodynamic or hydrodynamic body (3), in particular wing (3), forms at least a partial shift of the flap region boundary (21) by way of the back-flow flap (4) and the boundary component (5) thereof when the back-flow flap (4) is partially and/or completely raised, and the trailing edge separation vortex/vortices (1) and/or flap separation vortex/vortices (2) is/are thus influenced thereby, and in that the flap region boundary (21) is shifted completely to or beyond the profile trailing edge (6) or else only to a part before the profile trailing edge (6), and in that this is movably connected to a base element (23) on the wing, preferably permanently and/or so as to be detachable again for maintenance purposes, and thus makes possible a high service life of the rotor blade and/or wind turbine and/or flap system, preferably >5 years, particularly preferably >10 years, most preferably ≥20 years, and/or optionally makes simple removal/replacement possible.

38. Device according to any of the preceding embodiments, characterised in that this back-flow flap (4), with the wing (3) or alone, forms at least one parallelogram (10) and/or triangular (8) and/or circle segment (9) region, in particular a self-moving back-flow flap (8, 9, 10), and in that at least one passive and/or active back-flow flap (8, 9, 10) is created.

39. Device according to any of the preceding embodiments, characterised in that a face of the back-flow flap (4, 8, 9, 10) in the base position (lying in contact) is formed in a direction approximating a direction parallel (horizontal) to the profile surface, or at an angle of >30 degrees, preferably at an angle of >45 degrees, particularly preferably at an angle of >60 degrees to the profile surface as a back-flow flap (4, 8, 9, 10) and/or spoiler/rudder flap and/or braking flap.

40. Device according to any of the preceding embodiments, characterised in that the back-flow flap (4, 8, 9, 10) can be attached at any point on and/or in the wing (3) and/or the aerodynamic or hydrodynamic integration thereof does not require complete penetration through the shell and/or sandwich construction.

41. Device according to any of the preceding embodiments, characterised in that the superelevation during retroactive and/or external attachment of the back-flow flap (4, 8, 9, 10) to the wing (3) occurs by means of an aerodynamically or hydrodynamically configured flap transition (20), for example in the form of a diagonal or curve, preferably with a curved and resilient cover strip.

42. Device according to any of the preceding embodiments, characterised in that the joint (7) of the boundary components (5) of the back-flow flap (4) can be formed by a rotating and/or resilient hinge (11) and/or resilient component material.

43. Device according to any of the preceding embodiments, characterised in that the active back-flow flap (4) is moved by means of at least one actuator (15), for example mechanically (for example by way of levers, rods, ropes, springs) and/or electrically (for example by way of electromagnets, linear or rotary electric motors) and/or hydraulically (for example by way of cylinders or motors) and/or pneumatically (for example by way of cylinders, hoses (13), parallelogram hose (10), triangular hose (8), flat hose, circle segment hose (9) or pneumatic motors/actuators) and/or magnetorheological fluid or polymer.

44. Device according to any of the preceding embodiments, characterised in that the back-flow flap (4) undergoes excursion limitation for example by ropes, wires, rods, levers, strips, springs, walls, films, folded structure and/or actuator element (22).

45. Device according to any of the preceding embodiments, characterised in that the components of the back-flow flap (4) are given a for example curved/embossed and/or bionic (sharkskin structure) and/or otherwise known reinforcement and/or aerodynamic improvement structure at least in part for reinforcement (static improvement against oscillations).

46. Method of a safety system for preventing dangerous operating states and/or of a resource/energy efficiency improvement system for influencing the flow of an aerodynamic or hydrodynamic body (3), in particular of systems (for example energy generating systems or aircraft) equipped with aerofoils, following the principle of a back-flow flap (8, 9, 10), characterised in that there are
d) a fluid flow speed measurement in the environment of the wing and/or
e) a direct and/or indirect wing load measurement,
f) so as thus to control and/or regulate an active and/or passive flow influence of the wing (3).

47. Method of a safety system for preventing dangerous operating states and/or of a resource/energy efficiency improvement system for influencing the flow of an aerodynamic or hydrodynamic body (3), in particular of systems (for example energy generating systems or aircraft) equipped with aerofoils, following the principle of a back-flow flap (8, 9, 10), characterised in that there are
a) a fluid flow speed measurement in the environment of the wing and/or
b) a direct and/or indirect wing load measurement,
c) so as thus to control and/or regulate an active and/or passive flow influence by way of back-flow flaps and/or spoilers/flaps and/or braking systems (braking parachutes and/or braking flaps and/or overpressure and underpressure compensation systems) of the wing (3).

48. Method of a safety system for preventing dangerous operating states and/or of a resource/energy efficiency improvement system for influencing the flow of an aerodynamic or hydrodynamic body (3), in particular of systems (for example energy generating systems or aircraft) equipped with aerofoils, following the principle of a back-flow flap (8, 9, 10), characterised in that there are
a) a fluid flow speed measurement in the environment of the wing and/or
b) a direct and/or indirect wing load measurement and/or
c) measurement systems for detecting further dangerous operating states,
d) so as thus to control and/or regulate an active and/or passive flow influence by way of back-flow flaps and/or spoilers/flaps and/or braking systems (braking parachutes and/or braking flaps and/or overpressure and underpressure compensation systems) of the wing (3).

49. Method of a safety system for preventing dangerous operating states and/or of a resource/energy efficiency improvement system for influencing the flow of an aerodynamic or hydrodynamic body (3), in particular of systems (for example energy generating systems or aircraft) equipped with aerofoils, following the principle of a back-flow flap (8, 9, 10), characterised in that there are
a) a fluid flow speed measurement in the environment of the wing by means of at least one camera system and/or
b) a direct and/or indirect wing load measurement by means of at least one camera system per wing (3), and/or
c) measurement systems for detecting further dangerous operating states,
d) so as thus to control and/or regulate an active and/or passive flow influence by way of back-flow flaps and/or spoilers/flaps and/or braking systems (braking parachutes and/or braking flaps and/or overpressure and underpressure compensation systems) of the wing (3).

50. Device of a hydraulic and/or pneumatic and/or magnetorheological actuator (2) without a piston for generating a 2-dimensional actuator movement (11) and actuator force, preferably a rotational movement and a torque, characterised in that said actuator (2) consists of at least one face/wall (5, 6, 7), preferably of 3, particularly preferably 4, even more preferably of an even number of faces/walls (5, 6, 7), and at least one fluid-fillable space (10), and of at least one joint element (9).

51. Device of a hydraulic and/or pneumatic and/or magnetorheological actuator (2) without a piston for generating a 2-dimensional actuator movement (11) and actuator force, preferably a rotational movement and a torque, characterised in that the entire actuator (2), in a possible first position, for example a folded-up rest position, takes on a flat outer contour similar to a preferably thin plate and, in a second possible and preferred position, for example twisted through 90 angular degrees, takes on an unfolded operating position, and thus itself and/or the attached device form/forms for example a shape of a polygonal cross section outer contour, for example triangular square, parallelogramic, hexagonal, polygonal, scissor-shaped.

52. Device according to any of the preceding embodiments, characterised in that the fluid-fillable space (10) is preferably formed from a foldable actuator (2).

53. Device according to any of the preceding embodiments, characterised in that the actuator (2), in particular a joint element (9), preferably consists of a foldable hose (10) and/or foldable actuator (2).

54. Device according to any of the preceding embodiments, characterised in that the face(s) or wall(s) (6, 7, 8) are rigid or flexible but preferably rigid, and at least one face wall (6, 7, 8) is connected in an articulated manner and/or fixed to a base body (1).

55. Device according to any of the preceding embodiments, characterised in that the 2-dimensional actuator movement (11), in particular a rotational movement, of up to approximately 90 angular degrees, if a plurality of actuators (2) are arranged, particularly preferably 180 angular degrees, most preferably up to approximately 360 angular degrees with a plurality of deployed actuators (2) or more is made possible, and that this deployed arrangement in this case looks like a honeycomb structure.

56. Device according to any of the preceding embodiments, characterised in that the generated force acts in proportion to the effective actuator area and the pneumatic and/or hydraulic fluid pressure in the direction of the rotational movement (11), and thus exerts a torque via one or more faces/walls and/or devices/lever arms.

57. Device according to any of the preceding embodiments, characterised in that the actuator (2) is arranged in such a way that said actuator (2) can be moved and/or positioned, at least between these two positions, in the form of a rotational movement about at least one, preferably at least 3, more preferably at least 4 joint elements (9).

58. Device according to any of the preceding embodiments, characterised in that the joint(s) (9) is/are formed by the actuator (2) itself, and in that said actuator (2) is in the form of an at least 2-dimensionally radially deformable and/or resilient hose/sheath (10), particularly preferably at least 2 hoses/sheaths (10) placed one inside the other, it being possible for the face(s)/wall(s) (6, 7, 8) to be arranged in-between and/or externally and/or internally.

59. Device according to any of the preceding embodiments, characterised in that the arrangement of a plurality of actuators (2) of this type against one another, for example 2 actuators (2) rotated through 90 angular degrees and interconnected, make 2- and/or 3-dimensional movement possible.

60. Device according to any of the preceding embodiments, characterised in that a multi-wall arrangement of at least one actuator (2), in particular for increased safety, in particular for use in high-reliability and/or safety-related systems, is made possible.

Device according to any of the preceding embodiments, characterised in that the actuator (2) can take on an oscillation attenuation function.

61. Device according to any of the preceding embodiments, characterised in that the rotational movement (11) and force generation can take place by way of compressed air overpressure and/or underpressure, preferably overpressure and/or underpressure stores (25, 26), for example compressed air/CO₂ cartridges, for example for safety systems such as the emergency opening of escape doors, emergency closing of ventilation fire shutters.

62. Device according to any of the preceding embodiments, characterised in that the actuator (2) is moved towards at least one of the two positions in combination with a return movement, at least by means of a force, by for example spring force, gravity, manual force, external dynamic pressure/flow dynamic pressure and/or overpressure/underpressure, centrifugal force.

63. Device according to any of the preceding embodiments, characterised in that at least one face/wall (6, 7, 8) is straight or curved and/or reinforced, for example by way of macro-, micro-, nano-structuring, for example by means of curved structures made of metals or plastics materials, and/or reinforcements, for example by way of fibre composite plastics materials, such as GFRP or CFRP and/or nanoparticle reinforcements and/or surfaces such as carbon nanofibres.

64. Device according to any of the preceding embodiments, characterised in that the face/wall (6, 7, 8) is at least as rigid as a straight control plate without reinforcements made of 1 mm glass-fibre-reinforced plastics material (GFRP).

65. Device according to any of the preceding embodiments, characterised in that the front ends of the actuator (2) and/or hose and/or sheath (10) are configured by way of a curved base and/or fold structure and/or pressed flat and thus sealed in a fluid-tight manner and/or preferably planar in the folded state of the actuator (2).

66. Device according to any of the preceding embodiments, characterised in that the 2-dimensional actuator movement (11) is used for moving and/or exerting force and/or opening and/or closing and/or positioning and/or raising and/or orientating and/or displacing and/or lifting and/or switching components (4) fixed and/or not fixed thereto, for example for use for sorting/switching components (4), production parts, artificial moved joints and hands and feet for robots/humans, machines, actuators (2), measurement systems, buildings, protective sheaths for storm protection, automobile components (4) such as the steering system, folding top, door opener/closer, bumper, airbag, parking aids, mirror adjustment, windscreen wipers, headlights, containers, ducts, pumps, sheaths, flaps, levers, locks, doors, windows, safety systems, escape doors, ventilation fire shutters, tables, chairs, walls, clamping, vice, machine actuator (2) for tool change or machine movement axes, ramp such as lifting ramp and lifting stage and loading stage, theatre stage, lift, pivot arm, sorting stops, guide elements, flood protection elements, escape tunnels, steering systems, undercarriages, bonnets, cranes, bridges, presses and thermoforming devices, protection and escape tunnels, flood protection barriers, protective sheaths such as folding vehicle tops, ice removal systems on heavy goods vehicle canvases, building protective sheaths, protection systems such as collision protection optionally with explosive fluid gas pressure generation, for example airbag, bumper, engine bonnet, back-flow flaps and/or braking flaps on vehicles, in particular wings and tail units of aeroplanes, back-flow flaps and/or braking flaps on rotor blades of power generating systems such as wind turbines, terminals and plug-in connections of fluids, energy signals, or similar components (4).

Device according to embodiment 18, characterised in that the actuator (2) itself takes on at least in part a function of said aforementioned components (4).

67. Device according to any of the aforementioned embodiments, characterised in that the actuator (2) consists of a magnetorheological liquid/polymer and a magnetic-field-inducing element, preferably a magnet and/or an electric coil, particularly preferably of an electric coil in the fluid-filled space/hose (10).

68. Method of a hydraulic and/or pneumatic and/or magnetorheological actuator (2) without a piston, for generating a 2- or 3-dimensional actuator movement (11) and actuator force, in which
a) the entire actuator (2) takes on a possible first position, for example a folded-up rest position, preferably a low-pressure position, and
b) said actuator is moved into a second possible position, for example removed by 90 angular degrees, a folded-out working position, by a rotational movement (11) generated for example by overpressure.

69. Method according to embodiment 21, characterised in that the 2-dimensional actuator movement, in particular an actuator rotational movement (11), of up to approximately 90 angular degrees, particularly preferably up to approximately 180 angular degrees, brings about the at least one 1-dimensional movement and/or gripping of components (4) such as technological devices of any type.

70. Method according to any of embodiments 20 to 22, characterised in that the arrangement of a plurality of actuators (2) of this type leads to a 2- or 3-dimensional movement (11) of the entire actuator (2) and the components (4) and/or devices (19) to be moved, for example in artificial hands, robot arms or artificial limbs/prostheses for humans and animals.

71. Method for manufacturing the parallelogram actuator (2) according to the invention, characterised in that it is manufactured by the following steps:

producing the faces/walls (6, 7, 8) to appropriate dimensions
producing one or more hose(s)/sheath(s) (10), made to size and comprising a fluid supply, by cutting to length and/or vulcanising and/or welding and/or gluing and/or sealing and/or mechanical sealing
attaching the faces/walls to at least one hose/sheath (10), made to size and comprising a fluid supply, by gluing and/or sealing and/or riveting and/or vulcanising and/or screwing and/or hooking (hook and loop fastener) and/or shrinking a shrink-on film/hose (10) and/or by other mechanical methods

If it is necessary to provide two/three walls:

covering the actuator (2) made thus far with an outer sheath (10) comprising a fluid supply passage by the aforementioned methods and/or shrinking a shrink-on film/hose (10) and optionally attaching further faces/walls (6, 7, 8) by said methods
and/or
using a previously produced double-wall hose (10) in step a)

If required, after each process step, the actuator (2) can be tested for tightness using overpressure and underpressure and optionally subsequently filled with a process fluid/element, such as the magnetorheological liquid/polymer.

72. Method for manufacturing the parallelogram actuator (2) according to the invention, characterised in that this is manufactured by the following steps:

producing the faces/walls (6, 7, 8) to appropriate dimensions
producing one or more precursors of the hose(s)/sheath(s) (10), made to size and comprising a fluid supply, by cutting to length and/or vulcanising and/or welding and/or gluing and/or mechanical sealing
attaching the faces/walls to at least one planar precursor of the hose/sheath (10), comprising a fluid supply, by gluing and/or sealing and/or riveting and/or vulcanising and/or screwing and/or hooking (hook and loop fastener) and/or shrinking a shrink-on film/hose (10) and/or by other mechanical methods
sealing one or more planar precursors of the hose(s)/sheath (s), made to size and comprising a fluid supply, by cutting to length and/or vulcanising and/or welding and/or gluing and/or sealing and/or mechanical sealing

If it is necessary to provide two/three walls:

covering the actuator (2) made thus far with an outer sheath (10) comprising a fluid supply passage by the aforementioned methods and/or shrinking a shrink-on film/hose (10) and optionally attaching further faces/walls (6, 7, 8) by said methods
and/or
using a previously produced double-wall hose (10) in step a)

If required, after each process step, the actuator (2) can be tested for tightness using overpressure and underpressure and optionally subsequently filled with a process fluid/element, such as the magnetorheological liquid/polymer.

73. Device for a back-flow flap in particular in use in the field of aviation and wind energy, characterised in that it consists of a perforated film, preferably of plastics material, and has a thickness of 0.1 to 1 mm, preferably 0.2 mm, and has at least 5, preferably 10 holes/slits per cm², particularly preferably having at least 20 holes per cm².

74. Method for a perforated or slitted film as a back-flow flap, in particular of a passive back-flow flap, in particular in use in the field of aviation and wind energy, characterised in that at low angles of attack it leads to the profile curving (the film curving up with slight fluttering) in the region of the back-flow flap, and the back-flow flap rises in a known manner only when the angle of attack increases further.

75. Method for a perforated or slitted film as a back-flow flap, in particular of a passive back-flow flap, in particular in use in the field of turbines, characterised in that at low angles of attack it leads to the profile curving (the film curving up with slight fluttering) in the region of the back-flow flap, and the back-flow flap rises in a known manner only when the angle of attack increases further.

1-75. (canceled)

76. A device in the form of a wind turbine rotor blade comprising a passive or active flap system for improving the output,
comprising a base element which reinforces the rotor blade, and
at least one flap attached thereto,
wherein the base element comprises a support face on the rotor blade, and
wherein the flap is attached to the base element so as to be movable and is formed as a passive back-flow flap.

77. The device according to claim 76, wherein the movable attachment of the flap to the base element is formed using a joint made of resilient material, in particular in the form of film, textiles, in particular textiles comprising glass fibres or aramid fibres, one or more adhesive strips, in particular textile-reinforced or fibre-reinforced adhesive strips, or a hook and loop fastener, or wherein a support face of the back-flow flap is provided as base element and the support face forms 5% of the back-flow flap area upwards, in particular 10% of the back-flow flap area upwards, more particularly 20% of the back-flow flap area upwards, preferably 30% of the back-flow flap area upwards.

78. The device according to claim 76, wherein means for increasing the rigidity of the flap are provided, in particular a reinforcing, embossed, curved or honeycomb structure, in such a way that at least part of the flap has a high rigidity in the form of a tensile modulus of elasticity of at least 50 GPa and/or a tensile strength of at least 0.4 GPa.

79. The device according to claim 78, wherein the flap is reinforced by surface structures which provide a microstatic system, in particular lased, pressed, embossed, punched, printed, etched, or printed surface structures, and/or surface structures of the flap comprise ducts, in particular formed by embossments or punched parts, which positively influence the hysteresis of raising the back-flow flap.

80. The device according to claim 76, wherein means for limiting the excursion of the flap are provided and limit an opening angle of the flap of <90 degrees, preferably <75 degrees, particularly preferably <60 degrees, and/or the flap comprises at least one stop means for limiting a maximum deflection, in particular formed as a Kevlar string, wire, strips, lever, portion of a lift element of the flap itself, lamella, hose, grid, or bellows, preferably lateral bellows.

81. The device according to claim 76, wherein the base element is formed having at least one triangular or Z-shaped or V-shaped or leading-edge-shaped or polygonal base element portion in order to form a rotor blade trailing edge reinforcement, and/or the base element is designed to provide protection from external influences, in particular is provided as an antiadhesive film or having an antiadhesive coating, preferably at the trailing edge and/or at the leading edge of the rotor blade, and/or wherein the base element is provided at particular portions of the rotor blade or particular points on blade segments for attaching vortex generators and/or other base elements and/or flaps and/or lightning protection.

82. The device according to claim 76, wherein the base element comprises a noise-reducing formation of a flexibly and/or rigidly formed trailing edge, in particular toothed, jagged, bristly, perforated, slitted, thread-shaped, bird-feather-shaped, finger-shaped or spiral-shaped, and/or wherein the flap consists of at least one lift element which consists of at least one curved or even multiply curved plate and comprises a noise-reducing formation of a flexibly and/or rigidly formed trailing edge, in particular toothed, jagged, bristly, perforated, slitted, thread-shaped, bird-feather-shaped, finger-shaped or spiral-shaped.

83. The device according to claim 76, wherein the passive or active flap system is formed so as to be retrofittable and/or able to be removed again, and is attached to the base element in particular by adhesive connection having a large adhesive area, high-performance hook and loop fastener, wing scissors using gripping and/or frictional forces, rivet connection, screw connection, scissor connection, suspension connection, clamp connection or plug-in connection, preferably in such a way that the rotor blade structure remains statically unimpaired.

84. The device according to claim 76, wherein the rotor element comprises openings which can be opened and closed by the flap and/or lift element, between an upper face that guides overpressure and a lower face that guides underpressure, which openings can be used for lift reduction and/or for braking, at least in part by pressure compensation.

85. The device according to claim 76, wherein the flap consists of a flexible and/or resilient thin material, in particular metal or plastics material, and/or is reinforced by integrated textile reinforcing fibres, such as GFRP, CFRP, Kevlar, basalt or aramid fibres.

86. The device according to claim 85, wherein at low angles of attack the film leads to the profile curving, in particular the film curving up with slight fluttering, in the region of the back-flow flap, and the back-flow flap rises only when the angle of attack increases further in a known manner, for which purpose the flexible and/or resilient thin material consists in particular of a perforated and/or slitted film, preferably of plastics material, which has a thickness of 0.1 to 1 mm, preferably 0.2 mm, and has at least 5, preferably at least 10 holes and/or slits per cm², particularly preferably at least 20 holes per cm².

87. The device according to claim 85, wherein at least one oscillation attenuation element is provided for reducing the loads on the rotor blade structure and optionally hub structure, which element is provided in the form of at least one active and/or passive flap and reacts by mass compensation and/or pneumatically and/or hydraulically and/or magnetorheologically and has an attenuating effect by way of at least one passive and/or active lift element.

88. The device according to claim 85, wherein the back-flow flap has a rectangular or parallelogram outer contour which is in particular 2-dimensionally or 3-dimensionally curved.

89. The use of a perforated or slitted film as a back-flow flap, in particular as a passive back-flow flap, in particular during use in the field of aviation and/or wind energy and/or turbines, preferably in a device according to claim 86, wherein at low angles of attack the film leads to the profile curving, in particular the film curving up with slight fluttering, in the region of the back-flow flap, and the back-flow flap rises only when the angle of attack increases further in a known manner.

90. A method for operating a backflow flap, in particular a passive back-flow flap, formed using a perforated or slitted film, in particular during use in the field of aviation and/or wind energy and/or turbines, preferably in a device according to claim 86, wherein at low angles of attack the film leads to the profile curving, in particular the film curving up with slight fluttering, in the region of the back-flow flap, and the back-flow flap rises only when the angle of attack increases further in a known manner.
